(19) United States
(12) Patent Application Publication
(10) Pub. No.: US 2003/0014350 A1
(43) Pub. Date: Jan. 16, 2003

(54) Method and system for electronic report handling, such as for metrics reports concerning electronic auctions

(76) Inventors: Paula Duell, Austell, GA (US); Chuyu Xi, Kennesaw, GA (US); Niraj Khurana, Atlanta, GA (US); William A. Scott, Roswell, GA (US); Michell Ward, Alpharetta, GA (US); Vincio B. Tiburcio, Kennesaw, GA (US)

Correspondence Address: PERKINS COIE LLP, PATENT-SEA, P.O. BOX 1247, SEATTLE, WA, 98111-1247, US

(21) Appl. No.: 10/033,168

(22) Filed: Oct. 18, 2001

Related U.S. Application Data
(60) Provisional application No. 60/304,471, filed on Jul. 10, 2001.

(51) Int. Cl. G06F 17/60

(52) U.S. Cl. 705/37

(57) ABSTRACT

A system for providing metrics reports concerning reverse electronic auctions provides several components. The system includes a gather component for receiving electronic auction information from one or more electronic auction computers and a database for storing the electronic auction information. The system may also include a submission component for receiving requests for metrics reports from a user on a user computer, as well as a metrics report component for creating a metrics report which may be at least partially based on parameters supplied by the user and the electronic information stored in the database. Metrics reports may be used to track the reverse electronic auctions in order to determine where additional improvements and/or efficiencies can be made. Some or all steps in the process are performed electronically, or with electronic forms (e.g., Web-based forms), to eliminate bottlenecks and streamline the metrics report generation process.

### CROSS-REFERENCE TO RELATED APPLICATIONS

This application claims the benefit of U.S. Provisional Application No. 60/304,471 filed Jul. 10, 2001.

### TECHNICAL FIELD

The disclosure relates generally to electronic report handling, and more particularly, to handling electronic metrics reports relating to electronic auctions.

### BACKGROUND AND SUMMARY

Many businesses, particularly those in the manufacturing industries, wish to obtain raw materials and parts at the lowest possible price while ensuring quality, timely delivery and other factors important to the business. The requisitioning process for procuring materials or goods has often been a labor-intensive, inefficient and non-standardized process. In general, a buyer must first decide what he or she will buy; second, identify sources for items to be purchased; and third, identify what must be performed to qualify a source or an item supplied by a source.

The typical requisitioning process involved a number of steps. First, a buyer would identify something that needed to be purchased and when it must be delivered. The buyer would then determine whether a purchasing contract was in place for the item. If so, the existing purchasing contract would be employed. If not, the buyer would identify one or more suppliers capable of supplying the item. In addition to identifying suppliers, the buyer must prepare an RFQ, or “Request For Quotations,” which contains information suppliers need to prepare a bid or quotation. An RFQ will likely also include information or details regarding aspects of the item to be purchased that are important or critical to the buyer. When the RFQ is completed, identified suppliers receive the RFQ, such as by mail or e-mail.

Bids would then begin to trickle in from suppliers until some cutoff point. The buyer would then negotiate with one or more suppliers based on the received bids, and determine a supplier from whom to purchase the desired item. The buyer would then provide oral or written feedback to the suppliers identifying, for example, the supplier selected and possible reasons for the selection.

There are many bottlenecks in the process described above. For example, mailing or even e-mailing RFQs, particularly lengthy RFQs, leads to delays. Previous methods of identifying new suppliers not previously known to the buyer were haphazard, and approving such suppliers could be a lengthy process. Thus, buyers often failed to identify good alternative suppliers for a given item to be purchased. Preparing RFQs was a lengthy process, as each RFQ typically differed between buyers, and even between items purchased by a single buyer due, e.g., to differences between items and differing end uses. Many other problems resulted in bottlenecks in the requisitioning process.

One previously used method of improving the product requisitioning process was to identify common items to be purchased across business groups or by various buyers within a large organization. For example, a “Global Commodity Leader” (“GCL”) would be employed who had the responsibility to be a single commodity expert across an entire business (across distinct profit and loss centers). The GCL strategized where and how to purchase, how to leverage volume, and how to split purchases to best utilize or manage an available supply base. The GCL worked for a sourcing functional manager rather than directly for production within the organization. As indicated by their title, GCLs were expected to be familiar with the entire world's supply capability and price structure for their particular commodities. GCLs relied upon buyers to actually purchase items and ensure delivery. Nevertheless, despite the use of GCLs, many problems existed. The above process can be made more efficient.

Prior requisitioning systems were typically inefficient at managing high-volume activities, incapable of handling high-speed negotiations, incapable of purchasing foreign-manufactured goods, unable to leverage across business units, ineffective with communications and transactions, and fraught with time-zone problems and/or other problems. For example, an RFQ may have been provided to suppliers without providing the suppliers with corresponding adequate preparation time. After a supplier was selected, problems arose when a purchase order could not be immediately provided for that supplier because they must first be approved, or because of qualification issues regarding items to be purchased. In general, bottlenecks occur in generating and distributing the RFQ (e.g., gathering and including drawing and pictures, identifying leveraging opportunities), obtaining vendor numbers, updating purchasing systems, preparing a qualification plan (e.g., identifying test quantity, test site and protocol, test support personnel, past/fail criteria), qualification testing (e.g., obtain delivery of sample orders, executing the qualification plan, obtaining supplier participation when necessary, generating International Standards Organization (“ISO”) change requests), and providing supplier feedback. These are only some of the problems encountered under prior systems.

A reverse auction may be preferred for procurement. A “reverse auction” is one in which the purchaser states requirements, such as in a RFQ; then, suppliers who can meet the stated requirements compete for the business by offering the lowest price, quickest delivery, or whatever other conditions are sought by the purchaser. It is “reverse” because the usual competitive factor is price, and unlike a typical auction (“forward auction”), price goes down as the auction progresses.

The Internet is being used to increasingly conduct “electronic commerce.” The Internet comprises a vast number of computers and computer networks that are interconnected through communication channels. Electronic commerce generally refers to commercial transactions that are at least partially conducted by using the computer systems of parties to the transactions. For example, a purchaser can use a personal computer to connect to a vendor's computer via the Internet. The purchaser can then interact with the vendor's computer to conduct the transaction.

Although many of the commercial transactions performed today could be performed via electronic commerce, the acceptance and wide spread use of electronic commerce depends, in large part, upon the ease-of-use of conducting such electronic commerce. If electronic commerce can be easily conducted, then even the novice computer user will choose to engage in electronic commerce. Therefore, it is important that techniques be developed to facilitate conducting electronic commerce.

The World Wide Web portion of the Internet is especially conducive to conducting electronic commerce. Many Web servers have been developed through which vendors can advertise and sell products. These products can include items (e.g., music) that are delivered electronically to the purchaser over the Internet and items (e.g., books) that are delivered through conventional distribution channels (e.g., a common carrier). More generally, an item is any product, service, or exchangeable entity of any type. A server computer system may provide an electronic version of a catalog that lists items that are available. A user, who is a potential purchaser, may browse through the catalog using a browser and select various items to be purchased. When the user has completed selecting the items to be purchased, the server computer system prompts the user for information to complete the ordering of the items. This purchaser-specific order information may include the purchaser's name, the purchaser's credit card number and a shipping address for the order. The server computer system then typically confirms the order by sending a confirming Web page to the client computer system and schedules shipment of the items.

The World Wide Web is also being used to conduct other types of commercial transactions. For example, some server computer systems have been developed to support conducting auctions electronically. To conduct an auction electronically, the seller of an item provides a definition of the auction via Web pages to a server computer system. The definition includes a description of the item, an auction time period, and optionally a minimum bid. The server computer system then conducts the auction during the specified time period. Potential buyers can search the server computer system for an auction of interest. When such an auction is found, the potential buyer can view the bidding history for the auction and enter a bid for the item. When the auction is closed, the server computer system notifies the winning bidder and the seller (e.g., via electronic mail) so that they can complete the transaction.

### BRIEF DESCRIPTION OF THE DRAWINGS

FIG. 1 is a block diagram illustrating components used to implement the electronic auction metric system in one embodiment.

FIG. 2 is a block diagram illustrating components used to implement the electronic auction metric system in one embodiment.

FIG. 3 is a flow diagram illustrating the processing of a gather metrics data function in one embodiment.

FIG. 4 is a flow diagram illustrating the processing of a generate metrics report function in one embodiment.

FIG. 5 is a flow diagram illustrating the processing of a request to generate a metrics report in one embodiment.

FIG. 6 is a flow diagram illustrating the processing of a request to change information in one embodiment.

FIGS. 7-25 are Web pages that illustrate the user interface of the electronic auction metrics system in one embodiment.

FIG. 26 illustrates the data structure of a metrics database in one embodiment.

FIGS. 27-33 are Web pages that illustrate the user interface of the electronic auction metrics system in one alternative embodiment.

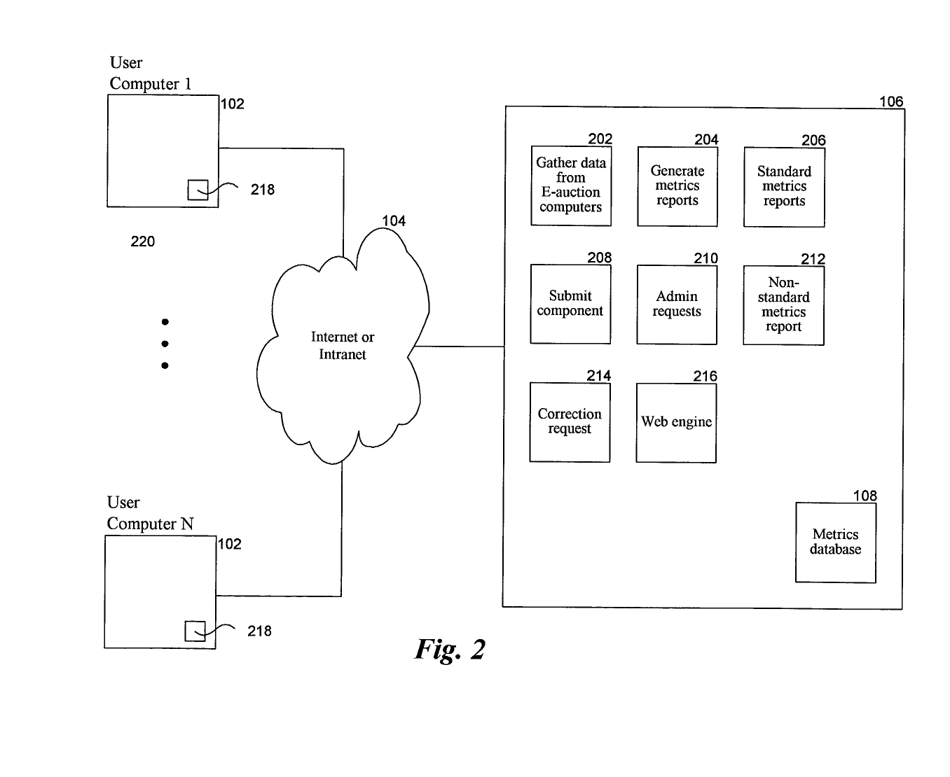

In the drawings, identical reference numbers identify identical or substantially similar elements or acts. To easily identify the discussion of any particular element or act, the most significant digit or digits in a reference number refer to the Figure number in which that element is first introduced (e.g., block 204 is first introduced and discussed with respect to FIG. 2).

The headings provided herein are for convenience only and do not affect the scope or meaning of the claimed invention.

### DETAILED DESCRIPTION

A system and process for monitoring and tracking electronic auctions, and preparing and distributing metrics of the electronic auctions, is described in detail below. In the following description, numerous specific details are provided, such as specific ordering of processes, types of reports, and the like, to provide a thorough understanding of, and enabling description for, embodiments of the invention. One skilled in the relevant art, however, will recognize that the invention can be practiced without one or more of the specific details, or with other functions, tasks or processes, etc. In other instances, well-known structures or operations are not shown, or are not described in detail, to avoid obscuring aspects of the invention.

In general, brief definitions of several terms used herein are preceded by the term being enclosed within double quotation marks. Such definitions, although brief, will help those skilled in the relevant art to more fully appreciate aspects of the invention based on the detailed description provided herein. Such definitions are further defined by the description of the invention as a whole (including the claims) and not simply by such definitions.

Prior attempts to automate the requisitioning process included using e-mail. However, e-mail often has limitations in sending large electronic documents. Further, many steps in the process described above are manual. Server computer systems have been developed to conduct reverse auctions electronically. To conduct a reverse auction electronically, the buyer of an item provides a definition of the auction via Web pages to a server computer system. A “buyer,” as generally used herein, refers to an individual or group that works for production and is chiefly responsible for maintaining work flow by contracting for and ensuring delivery of purchased items. Buyers are typically very familiar with a finite scope of purchased items, established suppliers of those items, and the logistics and timing issues involved with procuring those items. The definition of an auction can include an electronic request for quotations (RFQs), and can also include information about the date and duration of an electronic auction, special requirements, and requirements for suppliers, among other things. The RFQ must contain sufficient information to permit the least experienced supplier to adequately prepare a quote. Thus, items to be purchased must be described in as much detail as possible. Projected quantities to be purchased and anticipated delivery date requirements should also be stated in the RFQ. Shipping and currency preferences should be identified (e.g., all quotes in US dollars, pricing Free on Board (“FOB”) Charleston, S.C., etc.). The RFQ should also indicate whether bidder participation is required in preauction conferences, in technical reviews, or in other required procedures before, during or after the auction.

The electronic auction is conducted by receiving the bids from potential suppliers. Typically, under a reverse auction, the auction is held for a reasonable period of time, e.g. one to three hours, with extension logic. Extension logic effectively extends the time limit for the auction if significant activity occurs with respect to the items identified in the RFQ. Such short auctions permit international participation despite distant time zones and thus, may require bidding at all different hours of the day depending upon the current time in a supplier's time zone. An example of an electronic auction system that may be employed is the LiveExchange System by Moai of San Francisco.

A winner is selected in the auction system and the electronic auction ends. When the electronic auction ends, results of the auction are made available throughout a team of individuals or automated reporting tools. These results may be provided to the auction owner within a reasonable time after the auction, such as within 12 hours. Results of the auction are tabulated, and the GCL, buyer, or both determine from which supplier orders are to be filled. Qualified suppliers who have underbid their prior prices may get immediate purchase orders. The lowest bid does not necessarily equal the lowest cost. In some cases, a “comments” field associated with an auction may be as important as a supplier's bid (in a “bid” input field), since the comment may contain sufficient justification to procure from a supplier other than the lowest bidder. Such considerations may include services the supplier provides (e.g., warehousing, shipping, delivery, restocking, etc.) and quality (e.g., as it affects consumption rate, where half the price at three times the consumption rate would not correspond to a favorable bid). Further details regarding reverse electronic auctions may be found in U.S. patent application No. 09/754,024, filed Jan. 3, 2001, entitled Method And System For Providing International Procurement, Such As Via An Electronic Reverse Auction (Attorney Docket No. 243768038US), in U.S. patent application No. 09/754,028 filed Jan. 3, 2001, entitled Method and System for Electronic Document Handling, Such as For Requests For Quotations Under an Electronic Auction (Attorney Docket No. 243768027US), and U.S. patent application No. 09/754,023, filed Jan. 3, 2001, entitled Method and System for Assigning and Tracking Tasks, Such As Under An Electronic Auction (Attorney Docket No. 243768039US), all of which are incorporated herein by reference.

Metrics are desired in order to track the savings achieved through electronic auctions and to provide tools for analysis necessary to improve the electronic auction process. The metrics data from electronic auctions performed by different business units has often been in a wide variety of formats and was often incomplete or incorrect. The metrics data was often communicated to metrics tracking groups via e-mail, hand delivery, or interoffice mail, increasing the chances for delay and error. Moreover, previous systems to track metrics often required manual input of metrics information from various business groups into one or more central metrics databases, and delays and incorrect information were common. Personnel have also been frustrated with the menial task of manually inputting information.

As described in detail below, a method to convert a manual metrics tracking process, including metrics collection, processing, and report generation, to an automated Web-based model employs new processes to reduce or remove bottlenecks, inefficiencies, and errors and to ultimately improve overall product-purchasing efficiencies.

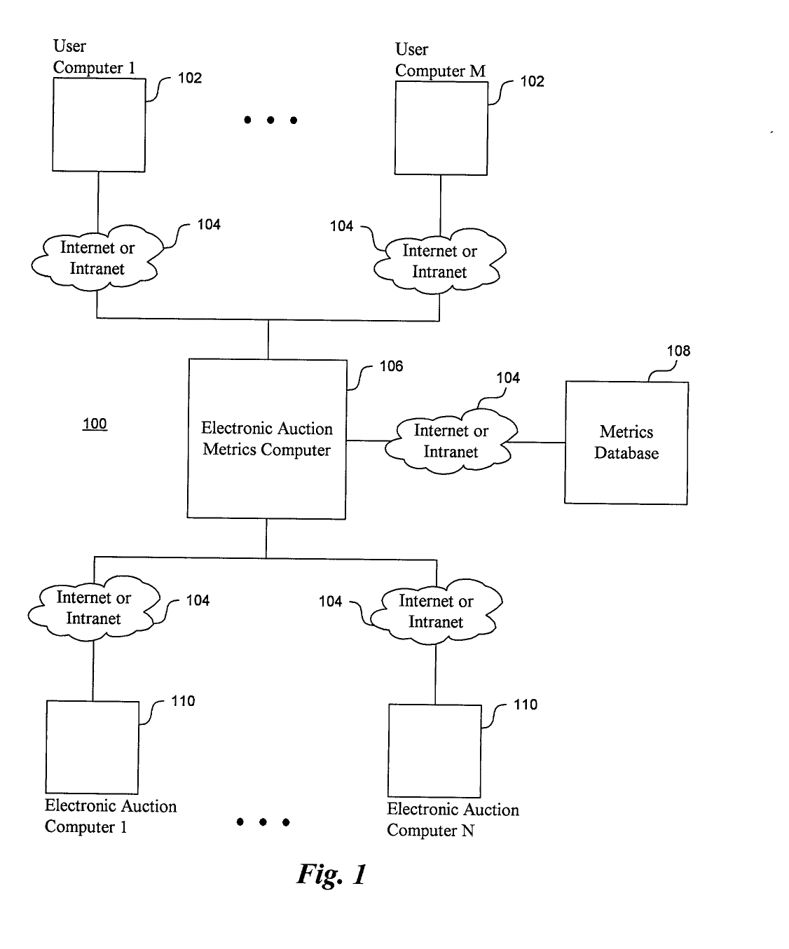

FIGS. 1 and 2 and the following discussion provide a brief, general description of a suitable computing environment in which aspects of the invention can be implemented. Although not required, embodiments of the invention will be described in the general context of computer-executable instructions, such as routines executed by a general purpose computer, e.g., a server or personal computer. Those skilled in the relevant art will appreciate that the invention can be practiced with other computer system configurations, including Internet appliances, portable computers, hand-held devices, personal digital assistants (PDAs), wearable computers, cellular or mobile phones, multi-processor systems, microprocessor-based or programmable consumer electronics, set-top boxes, network PCs, mini-computers, mainframe computers and the like. The invention can be embodied in a special purpose computer or data processor specifically programmed, configured or constructed to perform one or more of the computer-executable instructions explained in detail below. Indeed, the term “computer”, as used generally herein, refers to any of the above devices, as well as any data processor.

The invention can also be practiced in distributed computing environments, where tasks or modules are performed by remote processing devices, which are linked through a communications network, such as a Local Area Network (“LAN”), Wide Area Network (“WAN”) or public network such as the Internet. In a distributed computing environment, program modules or sub-routines may be located in both local and remote memory storage devices. Aspects of the invention described below may be stored or distributed on computer-readable media, including magnetic and optically readable and removable computer discs, as well as distributed electronically over the Internet or over other networks (including wireless networks). Those skilled in the relevant art will recognize that portions of the invention reside on a server computer, while corresponding portions reside on a user computer, for example. Data structures and transmission of data particular to aspects of the invention are also encompassed within the scope of the invention.

Unless described otherwise, the construction and operation of the various blocks shown in FIGS. 1 and 2 are of conventional design. As a result, such blocks need not be described in further detail herein, as they will be readily understood by those skilled in the relevant art.

Referring to FIG. 1, a block diagram illustrating an example of the components of an electronic auction metrics system is shown. The electronic auction metrics system 100 includes one or more user computers 102, an electronic auction metrics computer 106, a metrics database 108, and one or more electronic auction computers 110. The electronic auction metrics computer facilitates compilation of metrics data gathered from the electronic auction computers. The electronic auction metrics computer and the electronic auction computers are connected via a computer network 104, such as the Internet, an intranet, a LAN, a WAN, a wireless network or the like. Electronic auction computers are computer systems designed to host and manage reverse electronic auctions. Storage of metrics data is performed by the metrics database, which may be part of the electronic auction metrics computer or connected to it via a computer network. The metrics database may be any type of computer database, and one of ordinary skill in the art will recognize that many alternatives are possible. In one embodiment, a database from Oracle Corporation or a database such as Microsoft Access may be used. Users may request and/or receive metrics reports from a user computer, which may be connected to the electronic auction metrics computer via a computer network.

These computers may include a central processing unit, memory, input devices (e.g., keyboard and pointing devices), output devices (e.g., display devices and printers) and storage devices (e.g., optical and/or magnetic disk drives), all not shown in FIG. 1, but well known to those skilled in the relevant art. The memory and storage devices are computer-readable media containing computer instructions that implement the auction system. The user computers may use a browser to access and exchange data with the Internet, including web sites within a World Wide Web (“Web”) portion of the Internet. While one server computer is generally shown in FIG. 1, more than one server computer may, of course, be employed, such as a server computer for interacting with the user computers, another server computer for interacting with the electronic auction computers, and a third Web server computer for handling some or all of the various electronic documents and pages described herein. While wired connections are shown, the various computers may be connected via wireless connections. The invention can be embodied in a special purpose computer or data processor specifically programmed, configured or constructed to perform one or more of the computer-executable functions described in detail herein. The invention can be practiced and distributed in computing environments where tasks or modules are performed by remote processing devices, which are linked by a communications network. Aspects of the invention described herein may be stored or distributed on computer-readable media, including magnetic, optically readable and removable computer disks, as well as distributed electronically over the Internet or other networks (including wireless networks). Those skilled in the relevant art will recognize that portions of the invention reside on a server computer, while corresponding portions may reside on other computers. Data structures and transmissions of data particular to aspects of the invention are also encompassed within the scope of the invention.

FIG. 2 is a block diagram illustrating components used to implement the electronic auction metrics system in one embodiment. The electronic auction metrics computer includes a gather component 202, a generate metrics report component 204, a standard metrics report component 206, a submit component 208, an admin component 210, a non-standard metrics report component 212, a correction request component 214, and a web engine 216. The electronic auction metrics computer also optionally contains a metrics database 108 if such metrics database is not located outside the electronic auction metrics computer and in communication via a computer network.

The gather component 202 receives metrics data from one or more metrics computers and stores the data in the metrics database. The metrics data may include the results of the electronic auction, performance results (e.g., number of bidders, time between bidders, details on any extensions of time), or any other relevant types of data. The generate metrics reports component 204 uses the metrics data and information provided by a user on a user computer 102 to generate a particular type of metrics report. The submit component 208 receives and handles requests for metrics data and metrics reports from user computers. An admin component 210 allows an administrator to perform various functions, such as adding or deleting users, changing permissions, performing corrections, or other administrative tasks. The standard metrics report component 206 and the non-standard metric report component 212 facilitate the creation of metrics reports. The standard metrics report component includes templates for a variety of standard reports, including both reports that are automatically generated and standard reports that are selected by a user. The non-standard metric report component allows for creation of customized metrics reports, such as when a user desires a metrics report with particular parameters (e.g., business group, timeframes, size of auction, etc.). The correction request component 214 allows users of the system to submit proposed changes to the metrics data (e.g. errors in the data noticed by the user) for review by an administrator. The web engine 216 receives HTTP requests and coordinates the sending of the HTTP response messages corresponding to the displays of the electronic auction metrics system.

As described in reference to FIG. 1, one or more user computers communicate with the electronic auction metrics computer via a computer network. Each user computer contains a browser 218, such as a Web browser, which enables and facilitates communication between the user and the electronic auction metrics computer.

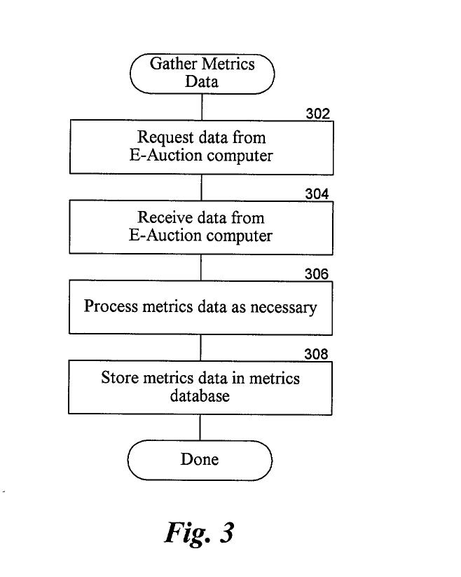

FIGS. 3-6 are flow diagrams illustrating aspects of the processing of the electronic auction metrics system. FIG. 3 is a flow diagram illustrating the processing of the gather component, which gathers data concerning electronic auctions performed on various electronic auction computers. The electronic auction metrics computer invokes this gather function when it is desired to gather data concerning electronic auctions performed on the electronic auction computers. For example, the gather function could be called on a regular time schedule (e.g., gather data every 24 hours), or the gather function could be requested by an administrator. Alternatively, electronic auction computers could automatically send the necessary data when an electronic auction is completed, for example, keeping the electronic auction metrics data as current as possible.

In block 302, the gather function requests metrics data from the electronic auction computer. In one embodiment, the request would include details about which data from the electronic auction was desired. Block 302 may be eliminated if electronic auction data is automatically sent to the electronic auction metrics computer from the electronic auction computer, or if an operator of the electronic auction computer proactively sends the electronic auction data. In block 304, the gather function receives the electronic auction data from the electronic auction computer. The gather function continues in block 306, where the function processes the data as necessary. In one embodiment, most of the data need not be processed, but certain pieces of data may be calculated by the function, such as the savings achieved from electronic procurement (which is the estimated cost of the product minus the actual cost after completing electronic procurement). In block 308, the metrics data is stored in the metrics database. “Metrics data” shall be defined as the electronic auction data as processed in block 306 and stored in the metrics database.

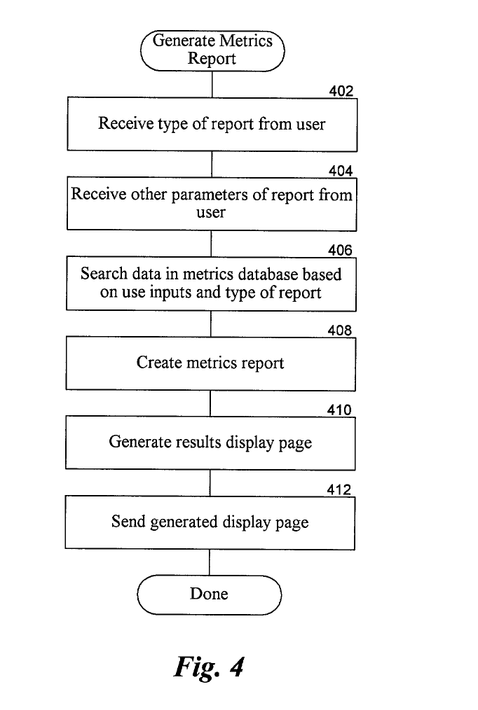

FIG. 4 is a flow diagram illustrating the processing of the generate metrics report component, which generates a metrics report based on parameters chosen by the user requesting the report and the metrics data in the metrics database. The electronic auction metrics computer invokes this generate function when a metrics report is requested by a user or at pre-defined intervals, such as for producing a set of monthly reports. In block 402, the generate function receives a requested type of metrics report from a user on a user computer. In one embodiment, pre-defined report formats are available for users to request. In block 404, the generate function receives other parameters of the report from the user. Any type of parameters could be input by the user, such as time, subject matter, or other limits on the metrics data to be included in the report. The generate function continues in block 406 where the generate function searches the metrics data in the metrics database based on the information received from the user in blocks 402 and 404. In block 408, the generate function compiles the metrics data found in the search of block 406 and creates a metrics report. The metrics report created is also based on the information received from the user in blocks 402 and 404. In one alternative embodiment, automatic reports are generated without user input, and blocks 402 and 404 are not necessary. In this embodiment, the generate function provides the report information such as from an automatic report template. The generate function continues in block 410, where the generate function generates a results display page that shows the metrics report, and in block 412, the generate function sends the generated display page to the user for display.

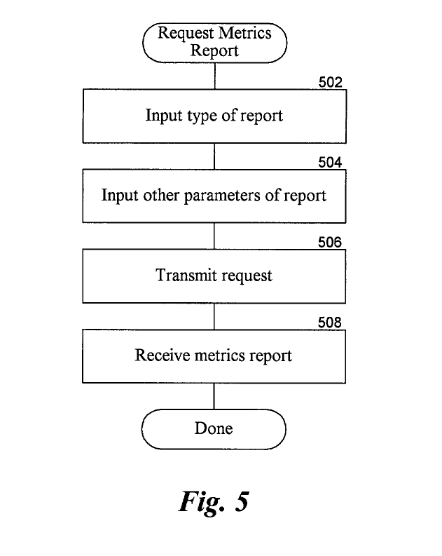

FIG. 5 is a flow diagram illustrating the process by which a user requests a metrics report that is based on inputted parameters. The request function of FIG. 5 may result in the activation of the generate function of FIG. 4. In block 502, the user inputs the type of report desired, which may be a standard style of report, a customized report, or a combination of the two. In block 504, the user inputs other parameters of the desired report. These parameters can include any sort of information to help define the final report, such as limitations on times (e.g., all electronic auctions in June 2001), subject matter (e.g., all electronic auctions involving tools), performance (e.g., all electronic auctions with a certain level of savings), or any other parameter. In block 506, the user transmits the request, such as by selecting a submit button on a web page. In block 508, the user receives the metrics report based in the inputted parameters. The user may receive the metrics report via any format, such as a screen display, electronic file delivery, or other delivery method.

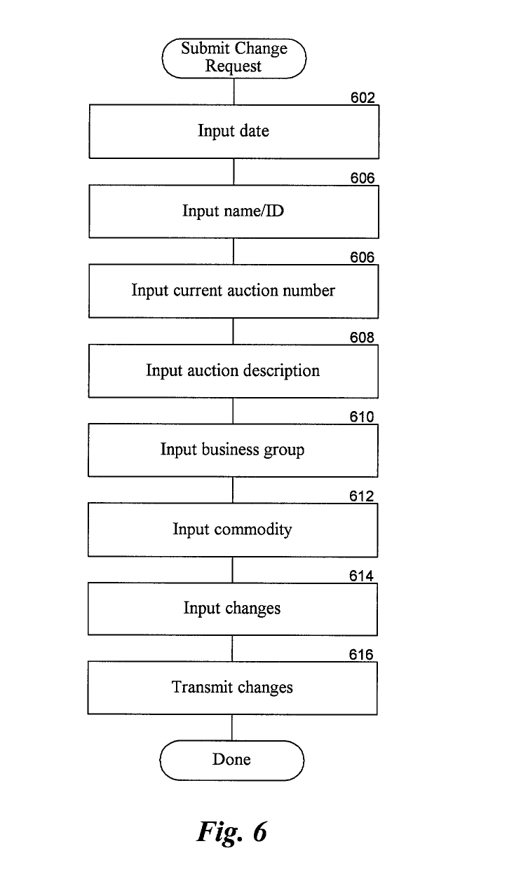

FIG. 6 is a flow diagram illustrating the process by which a user submits a change request. A user may desire to submit a change request when he or she notices an error in the information contained in the metrics database. For example, a user reviewing a report may notice an error in the results of one of the electronic auctions, making it desirable to facilitate the user's ability to submit a correction of the information. In blocks 602, 604, 606, 608, 610, 612, and 614 the user may submit information identifying the electronic auction for which a correction is desired. Any combination of the various pieces of information can be submitted as long as the information is sufficient to identify the relevant electronic auction. In block 602, the user inputs the date of the auction and in block 604 the user inputs a name or identification. Some of the pieces of information may be automatically input, such as the user's name or identification in block 604. In block 606, the user inputs a unique auction number to identify the electronic auction and in block 608, a description of the auction may be inputted. In block 610, the user may input a business group associated with the auction and in block 612 the user may input a commodity associated with the auction. The function continues in block 614 where the user inputs the changes that he or she thinks is necessary. In block 616, the user transmits the proposed changes and information to an administrator. In one embodiment, this is accomplished via an e-mail. An administrator may review the changes and decide whether a change to the database is appropriate.

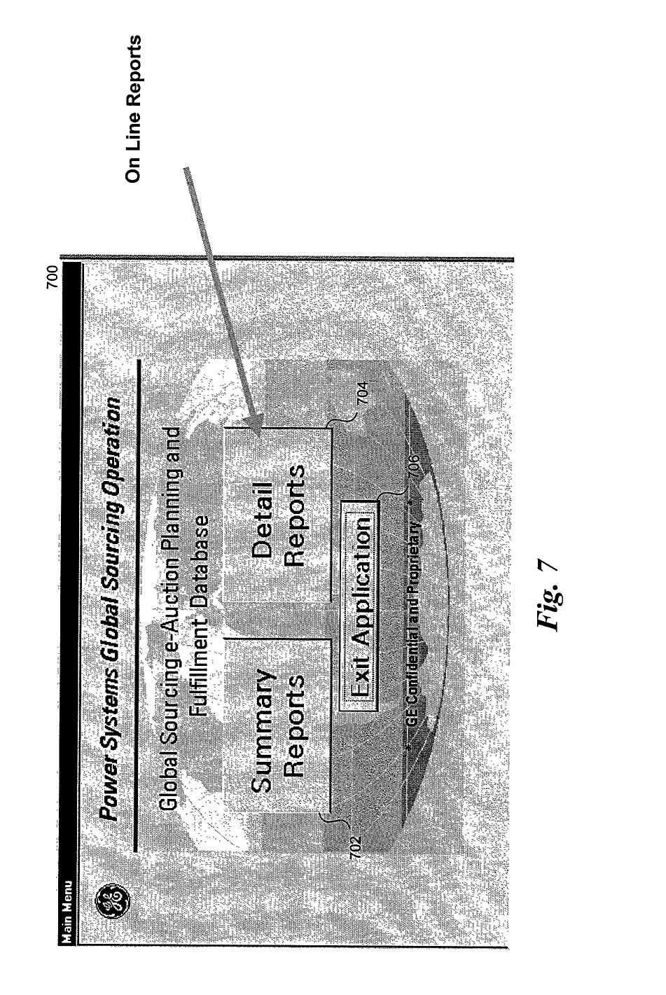

FIGS. 7-25 are Web pages that illustrate the user interface of the electronic auction metrics system in one embodiment. Many of the Web pages contain fields that allow for user input. Such fields may include drop-down menus, radio buttons and other user interface tools for assisting users in rapidly completing such electronic forms.

In general, Web or Internet-based tools enable multiple people to use centralized electronic forms to create, review and distribute critical information at a much higher speed than traditional paper-based systems. In one embodiment, non-standard reports may be created using electronic tools from Brio Technology of Santa Clara, Calif.

The Web pages may be implemented in XML (Extensible Markup Language) or HTML (HyperText Markup Language) scripts that provide information to a user, and may provide facilities to receive input data, such as in the form of form fields to be filled in; drop-down menus or entries allowing one of several entries to be selected; and buttons, sliders, or other known user interface tools for receiving user input in a Web page. Of course, while certain specific ways of displaying information to users in pages are shown and described herein, those skilled in the relevant art will recognize that various other alternatives may be employed. The terms “Web page” and “page” are generally used interchangeably herein. While XML and HTML are described, various other methods of creating displayable data may be employed, such as the Wireless Access Protocol (“WAP”).

FIG. 7 illustrates the main menu of the electronic auction metrics system. Web page 700 includes a summary report button 702, a detail report button 704, and an exit button 706. If a user would like to see summary reports, the summary report button may be selected. Similarly, more detailed reports are available by selecting the detail report button. The exit button may be selected by a user to exit the electronic auction metrics system application.

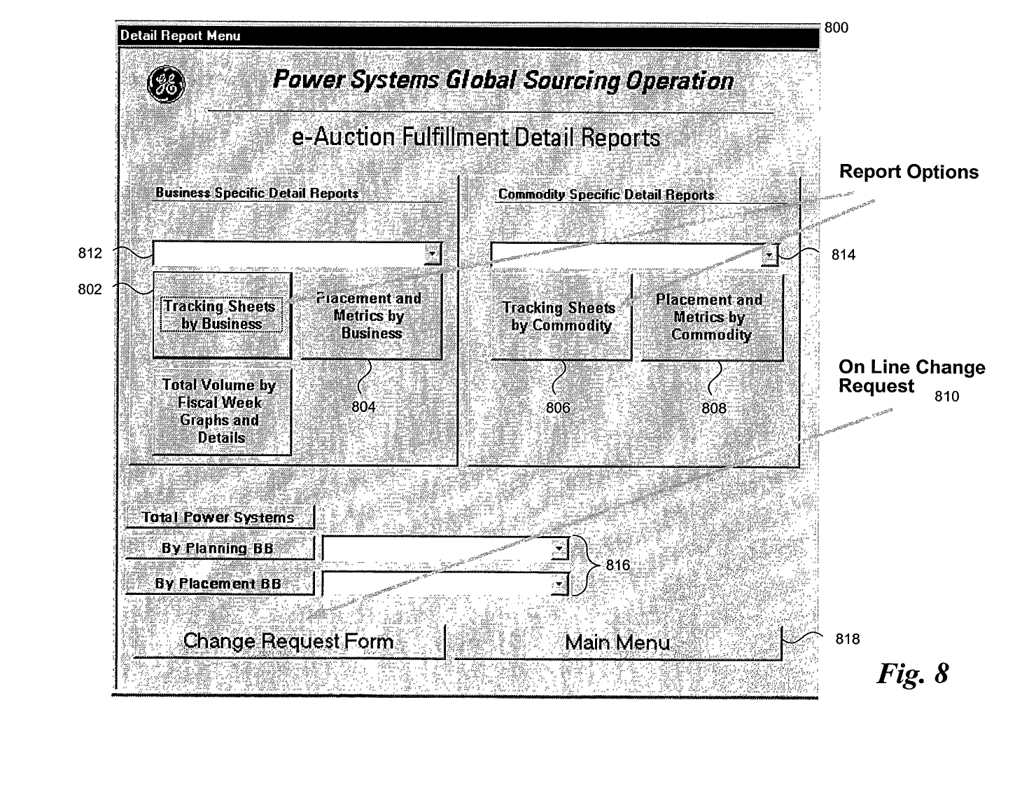

FIG. 8 illustrates the detail reports main menu of the electronic auction metrics system. Detail report web page 800 includes a variety of different buttons to allow a user to select detailed metrics reports, and detail report 800 is activated when the detail report button of the main menu of FIG. 7 is selected. Detail report 800 includes a tracking sheets by business button 802, which creates business-specific metrics reports for display to the user. In the depicted embodiment, the user would select a business from the business pull-down menu 812 before selecting the tracking sheets by business button, and the metrics reports created would be based on the selected business. A “business” as used herein represents a business organization, such as a division of a company, etc. Detail report 800 also includes a placement and metrics by business button 804, which creates business-specific metrics reports for display to the user when selected. The reports created by the placement and metrics by business button are also based on the business selected in the business pull-down menu. Detail report 800 further includes a commodity pull-down menu 814, a tracking sheets by commodity button 806, and a placement and metrics by commodity button 806. A “commodity” as used herein represents a particular item to be procured using a reverse electronic auction, such as a type of product, mechanical part, etc. After a commodity is selected with the commodity pull-down menu, the tracking sheets by commodity button and the placement and metrics by commodity button create metrics reports based on the selected commodity after those buttons are selected by the user.

Detail report 800 also includes a change request button 810, Black Belt pull-down menus 816, and a main menu button 818. The change request button activates a pop-up change request form when selected by a user. The change request form may be used to submit changes to the metrics database if the user notices an error. The Black Belt pull-down menus allows metrics reports to be further refined by selecting reports based on the planning Black Belt or the placement Black Belt. A “Black Belt,” as used herein, means a person with expertise and/or responsibility in a certain area (i.e., a placement Black Belt would have expertise in placement. The main menu button 818 returns the user to the main menu of FIG. 7.

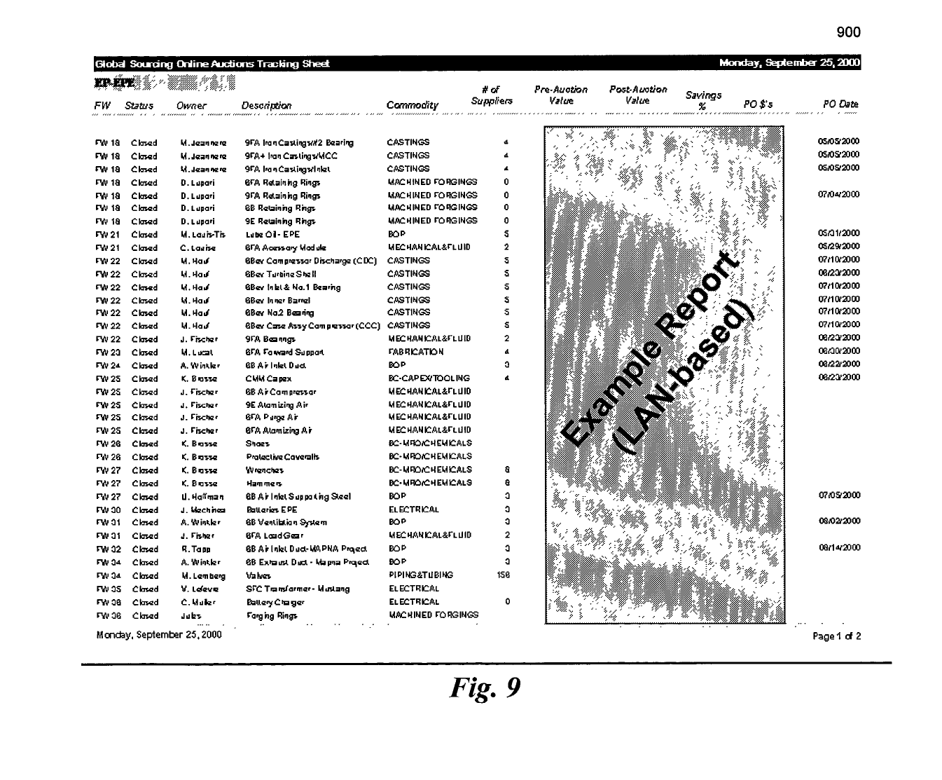

FIG. 9 illustrates a tracking sheet by business report of the electronic auction metrics system. The tracking sheet by business report includes a number of columns of information, in addition to header and general information. The tracking sheet by business report is created when a user selects the tracking sheets by business button, as described in relation to FIG. 8. From a field in the top left corner of the report it can be determined that the tracking sheet by business report is based on the business entitled “EP-EPE” which was selected from the business pull-down menu. The tracking sheet by business report includes a fiscal week column, a status column, an owner column, a description column, a commodity column, a supplier column, auction value columns, and a PO date column. In the depicted embodiment, the tracking sheet by business report shows information relating to many auctions that were conducted for the business EP-EPE. The fiscal week column includes the fiscal week in which an electronic auction was completed or will be completed. The status column includes the current status of each auction. The status is “closed” for all of the auctions in the depicted embodiment. The owner column includes the name or other identification for the person who has responsibility for the particular electronic auction. The description column includes a textual description of the auction, such as the product in the auction, and the commodity column includes the general class of commodity (e.g., castings, machined forgings, mechanical & fluid, etc.) involved in the electronic auction. The suppliers column includes the number of suppliers that bid on the electronic auction, and the PO Date column includes the data that the purchase order was completed.

The tracking sheet by business report also includes a variety of auction value columns, such as pre-auction value, post-auction value, savings, and PO value. The pre-auction value column includes the value of auctioned items based on prior pricing (or budgeted pricing if prior pricing is not available) times quantity. The post-auction value includes the value of auctioned items based on lowest bid times quantity. The savings column includes the sum of (starting bid prices for each offering times quantity of each offering) minus the post-auction value. In one embodiment, starting bid prices vary from actual previous prices paid in order to avoid publishing confidential pricing information of current and/or past suppliers. The PO value column includes the estimated value of the purchase orders.

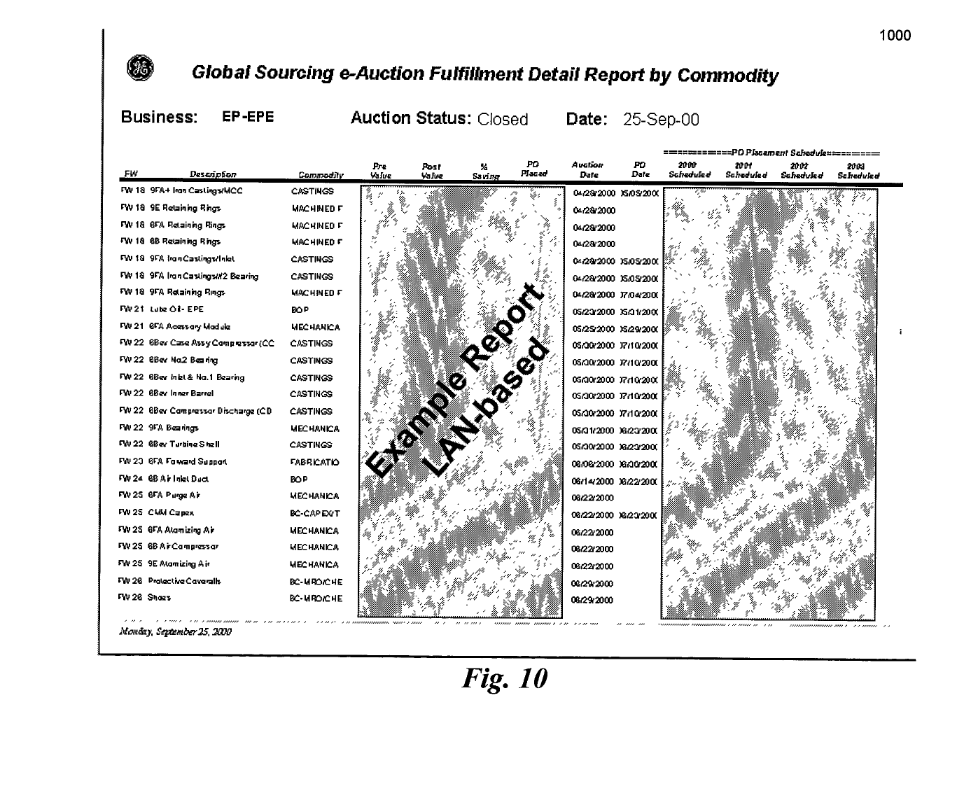

FIG. 10 illustrates a placement and metrics by business report 1000 of the electronic auction metrics system, which is created when a user selects the placement and metrics by business button, as described in relation to FIG. 8. From a field in the top left comer of the report it can be determined that the placement and metrics by business report is based on the business entitled “EP-EPE” which was selected from the business pull-down menu. The placement and metrics by business report includes a fiscal week column, a description column, a commodity column, auction value columns, an auction date column, a PO date column, and PO placement schedule columns. In the depicted embodiment, the placement and metrics by business report shows information relating to many auctions that were conducted for the business EP-EPE. The fiscal week column, description column, commodity column, auction value columns, auction date column, and PO date columns are all substantially similar in type of content as the equivalent columns described in relation to FIG. 9. The PO placement schedule columns include information about the project PO placements for future timeframes, such as future years.

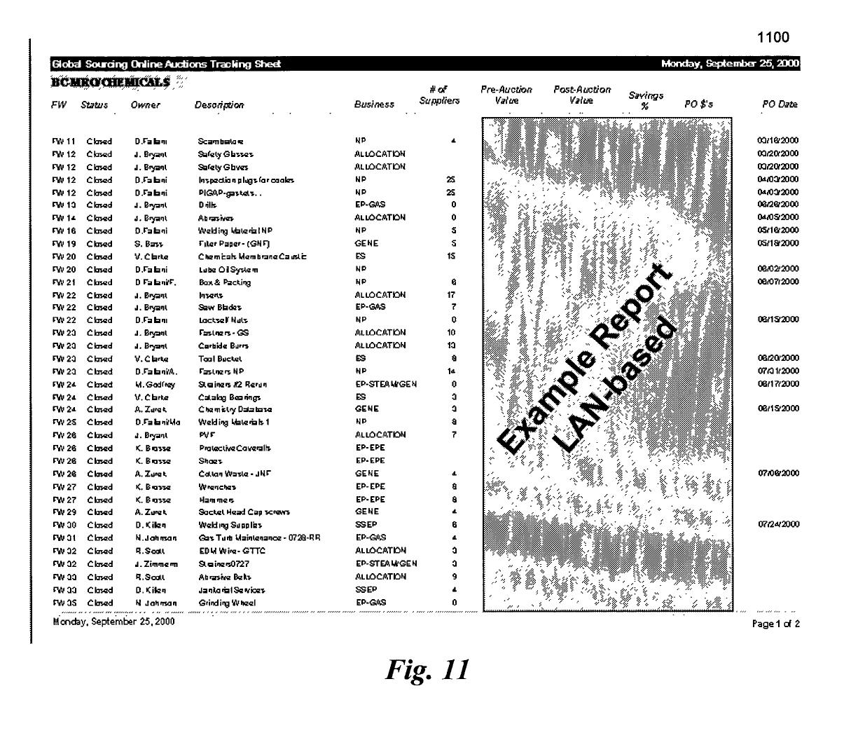

FIG. 11 illustrates a tracking sheets by commodity report 1100 of the electronic auction metrics system, which is created when a user selects the tracking sheets by commodity button, as described in relation to FIG. 8. From a field in the top left corner of the report it can be determined that the tracking sheets by commodity report is based on the commodity entitled “BC-MRO/Chemicals” which was selected from the commodity pull-down menu of FIG. 8. In the depicted embodiment, the tracking sheets by commodity report shows information relating to many auctions that were conducted for the commodity BC-MRO/Chemicals. The tracking sheets by commodity report includes the columns described in relation to FIG. 9, except that a business column replaces the commodity column. The business column includes information about which business for which the electronic auction was conducted.

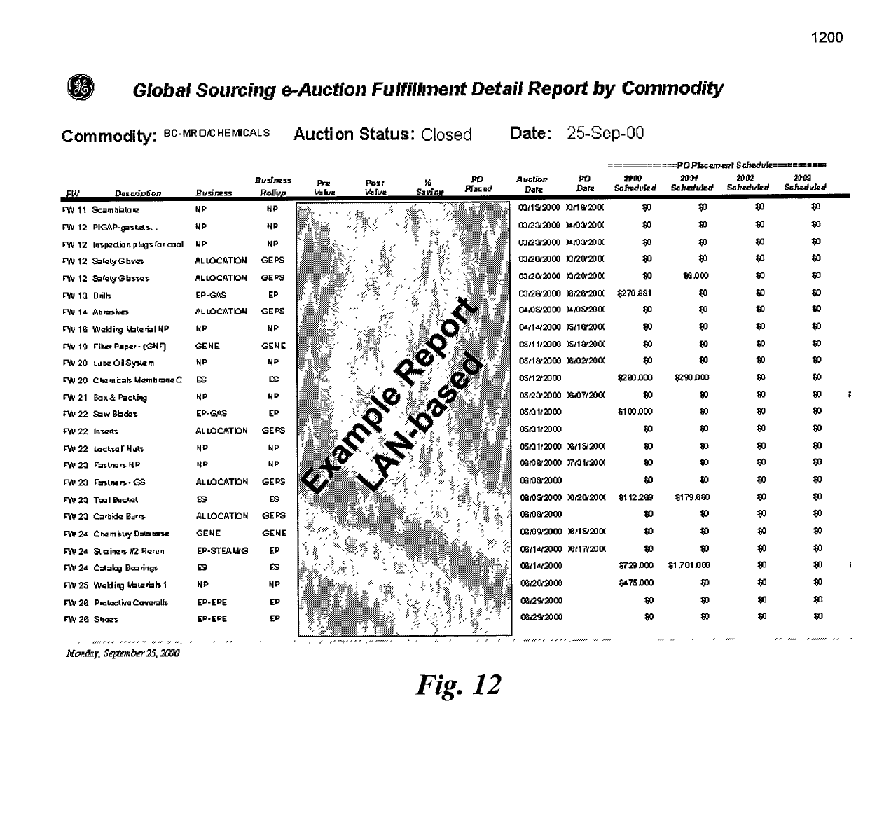

FIG. 12 illustrates a placement and metrics by commodity report 1200 of the electronic auction metrics system, which is created when a user selects the placement and metrics by commodity button, as described in relation to FIG. 8. From a field in the top left corner of the report it can be determined that the placement and metrics by commodity report is based on the commodity entitled “BC-MOR/Chemicals” which was selected from the commodity pull-down menu of FIG. 8. In the depicted embodiment, the placement and metrics by commodity report shows information relating to many auctions that were conducted for the commodity BC-MRO/Chemicals. The placement and metrics by commodity report includes the columns described in relation to FIG. 10, except that a business column replaces the commodity column. The business column includes information about which business for which the electronic auction was conducted.

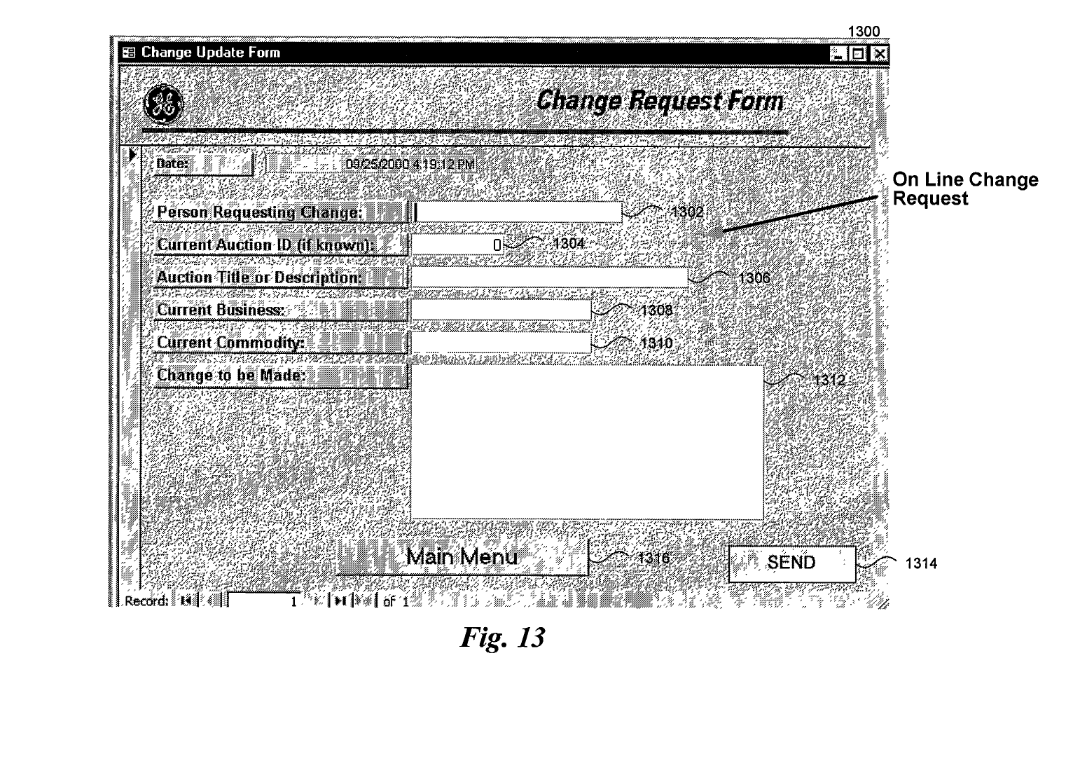

FIG. 13 illustrates the change request Web page of the electronic auction metrics system. The change request Web page is activated by selecting the change request button on the details report main menu of FIG. 8, and is typically used when a user desires to submit a change to the information in the metrics database. The change request Web page includes a requestor field 1302, an auction ID field 1304, an auction description field 1306, a business field 1308, a commodity field 1310, and a change field 1312. The user enters a name or other identification in the requester field to identify the source of the change request in case the administrator has questions or wishes to send confirmation of the resolution. In one embodiment, this information can be automatically entered by the system based on the user's login name or e-mail address. The user enters an auction ID in the auction ID field if the user has that information or the user could enter a description or title of the auction in the associate field if that information is available. In the business field and commodity field, the user may enter the business or commodity associated with the relevant electronic auction, respectively. In the change field 1312 the user may enter any recommended changes to the information in the database (e.g., correcting errors or updating information).

The change request Web page also includes a send button 1314 and a main menu button 1316. The send button will submit the changes and information entered in the previous fields to an administrator for review, and the main menu button will cancel the change request and return the user to the details report main menu of FIG. 8.

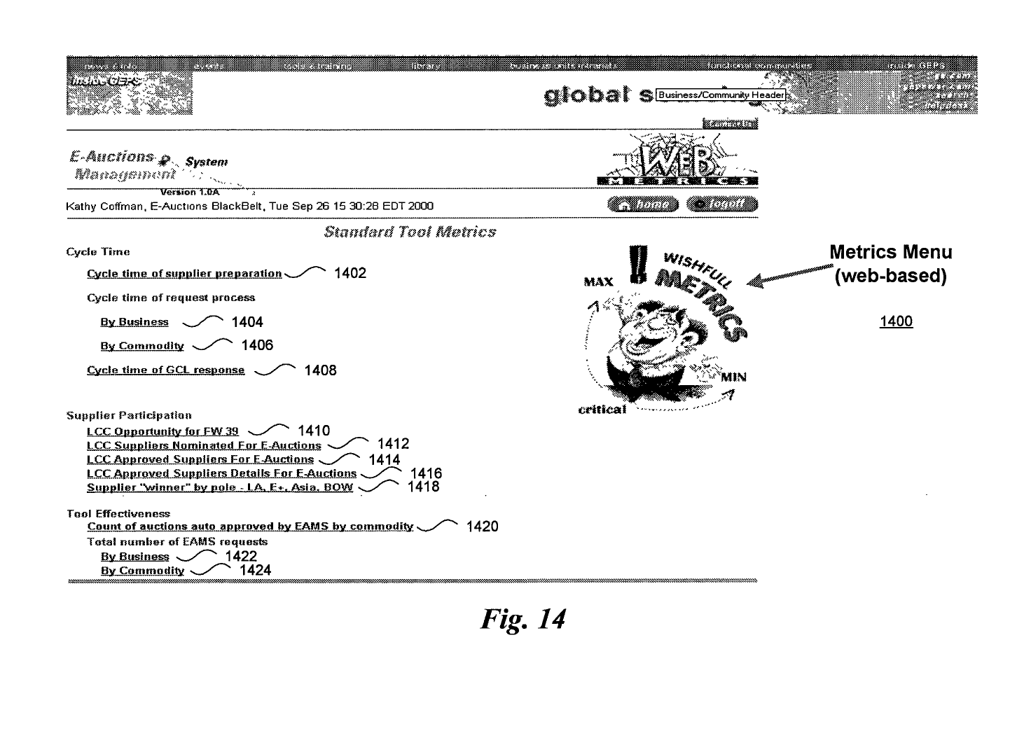

FIG. 14 illustrates the summary report main menu 1400 of the electronic auction metrics system. The summary report main menu includes, in the depicted embodiment, a variety of different links to allow a user to select summary metrics reports. The summary report main menu is activated when the summary report button of the main menu of FIG. 7 is selected. A list of links in a left column that are allows users to select different standard metric reports for display. The summary report main menu includes a list of cycle time links, where each cycle time link requests a metrics chart concerning an aspect of cycle time, or how long a particular aspect of an electronic auction took to perform The supplier preparation link 1402 provides a metrics report summarizing the amount of time that suppliers have to prepare their bids, based on the time between when the owner sends the RFQ to suppliers and the time that the auction is scheduled to begin. The request process by business link 1404 and the request process by commodity link 1406 generate metrics reports summarizing the total length of the electronic auction procurement process by business and commodity, respectively. The GCL response link 1408 provides a metrics report summarizing the time it took for the GCL to conduct review of an auction after the GCL was notified that the auction was awaiting review.

The summary report main menu also includes, in the depicted embodiment, supplier participation links and tool effectiveness links. The supplier participation links include an LCC opportunity link 1410, a LCC nominated suppliers link 1412, a LCC approved suppliers link 1414, a LCC approved suppliers details link 1416, and a supplier winner link 1418. “LCC” shall mean low cost country, as used herein. The LCC opportunity week allows users to see potential e-auction opportunities for LCC suppliers in the coming fiscal week (e.g., fiscal week 39). The LCC nominated suppliers link allows users to request a report that lists all the electronic auctions for which LCC suppliers have been nominated. The LCC approved suppliers link allows users to request a list of all the approved LCC suppliers, and the LCC approved suppliers details link provides more detailed information on those approved suppliers. The supplier winner link allows users to request a list of all winning LCC suppliers based on their pole. A “pole,” as generally used herein, refers to a specific region of the world that has been targeted as having a low-cost, high quality or other required supply base for items consumed by a purchasing organization. Examples of such poles include an Asian pole (includes Singapore, China, India, Japan, etc.), a European pole (includes the European countries), an Americas pole (includes Central and South American countries), the Balance of the World (BOW) pole, and the like. Poles may be also be defined based on smaller geographic regions, such as separate eastern and western European poles (rather than a single European pole). A pole may be a preferred source for particular items, such as the Asian pole for textiles and hand tools, due to labor costs within such regions. Pole personnel are generally local nationals working directly with suppliers and national commerce organizations to attract business into the geographic region. Thus, they work with the GCL, for example, to encourage bids under an electronic auction to suppliers within that pole.

The tool effectiveness links include a commodity count link 1420, a business total “EAMS” link 1422, and a commodity total “EAMS” link 1424. As used herein, “EAMS” generally refers to the electronic auction metrics system. The commodity count link provides users with a report on the total number of auctions that were automatically approved by the electronic auction metric system, organized by commodity. The business total EAMS link 1422 and commodity total EAMS link 1424 provide an indication of the usage of the electronic auction metric system by including information about how many times the system has been accessed by persons associated with a particular business or commodity, respectively.

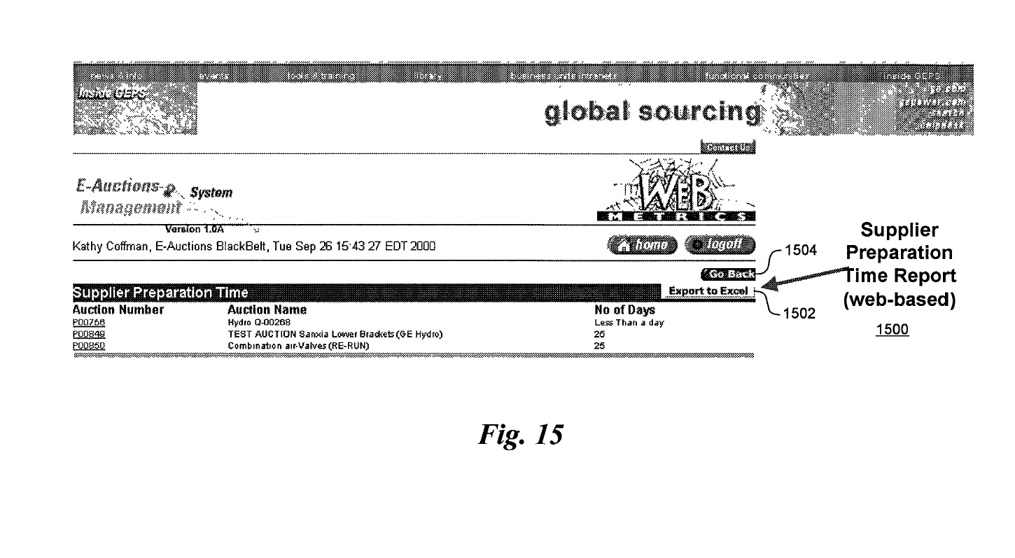

FIG. 15 illustrates a cycle time of supplier preparation Web page 1500 of the electronic auction metrics system. The cycle time of supplier preparation Web page is created when a user selects the supplier preparation link, as described in relation to FIG. 14, and can be used to track how long suppliers had to prepare a bid in response to a RFQ. The cycle time of supplier preparation Web page includes an auction number column, an auction name column, and a number of days column. The auction number and auction name columns provide identification of the electronic auction being represented. The number of days column includes the total time (in days) that the suppliers had to prepare a bid after receiving the RFQ and before the start of the auction. Export button 1502 will export the data in the cycle time of supplier preparation Web page to a file compatible with a spreadsheet, such as Microsoft Excel. Back button 1504 returns the user to the summary report main menu of FIG. 14.

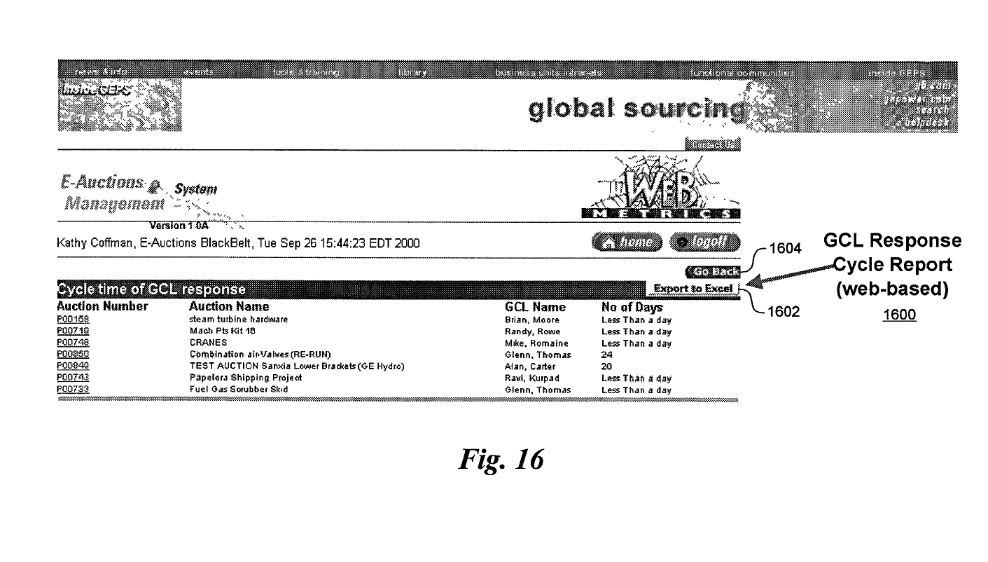

FIG. 16 illustrates a G-CL response time web page 1600 of the electronic auction metrics system. The GCL response time web page is created when a user selects the GCL response time link, as described in relation to FIG. 14, and indicates how long each GCL is taking to approve an auction, which could be a potential choke point. The GCL response time web page is similar in format to web page 1500 except that it includes a GCL name column. The GCL name column includes the name or other identification of the GCL associated with a particular electronic auction. The number of days column of web page 1600 includes information about the length of time it took for the GCL to complete review of an auction after receiving notification that the auction was ready for review. Export button 1602 will export the data in the GCL response time web page to a file compatible with a spreadsheet, such as Microsoft Excel. Back button 1604 returns the user to the summary report main menu of FIG. 14.

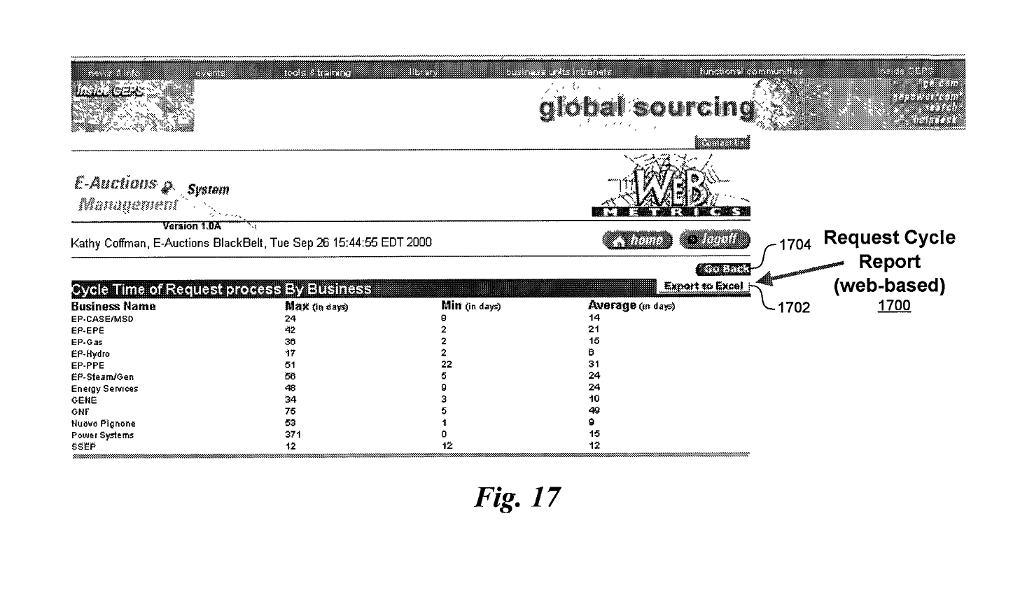

FIG. 17 illustrates a cycle time of request process by business web page 1700 of the electronic auction metrics system. The cycle time of request process by business web page is created when a user selects the business link, as described in relation to FIG. 14, and indicates how long each electronic auction took from beginning to end for each by business, which could indicate a particular business that needs to improve its processes. The cycle time of request process by business web page includes a business name column, a maximum column, a minimum column and an average column. The time of request process by business web page compiles the metrics information for all electronic auctions completed for a particular business and displays the results. The business name column includes the name of the business organization for which summary metrics information is provided. The minimum column and the maximum column include the shortest electronic auction time and the longest electronic time, respectively, for the business organization identified in the business column. Similarly, the average column provides the average electronic auction time for that business. Export button 1702 will export the data in the cycle time of request process by business web page to a file compatible with a spreadsheet, such as Microsoft Excel. Back button 1704 returns the user to the summary report main menu of FIG. 14.

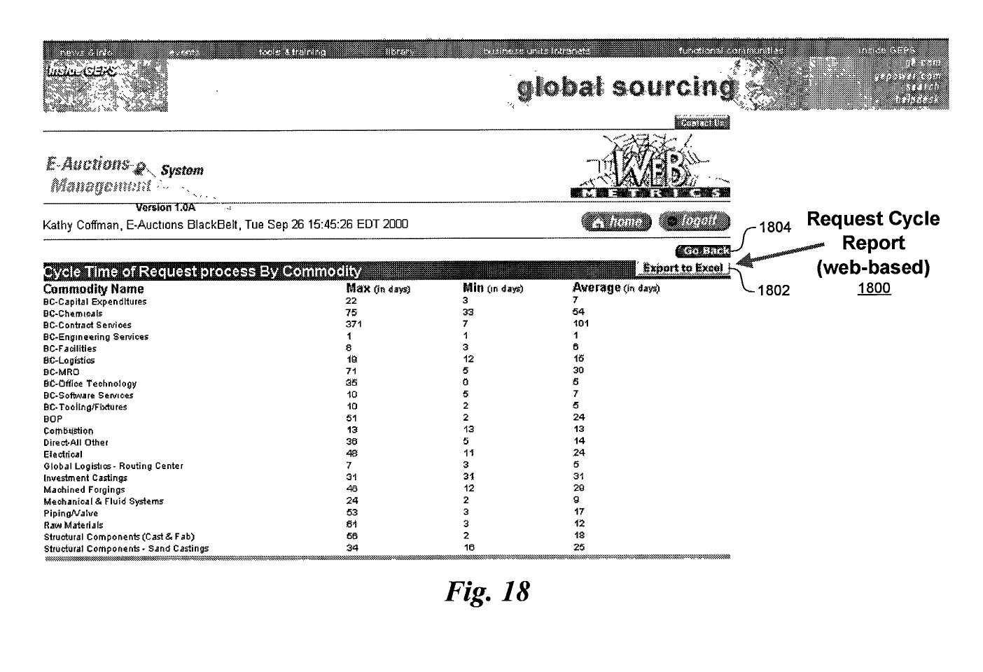

FIG. 18 illustrates a cycle time of request process by commodity Web page 1800 of the electronic auction metrics system. The cycle time of request process by commodity Web page is created when a user selects the commodity link, as described in relation to FIG. 14, and indicates how long each electronic auction took from beginning to end for each by commodity, which could indicate a particular commodity that has inefficiencies in its procurement process. The cycle time of request process by commodity Web page includes a commodity name column, a maximum column, a minimum column and an average column. The time of request process by commodity Web page compiles the metrics information for all electronic auctions completed for a particular commodity and displays the results. The commodity name column includes the name of the commodity for which summary metric information is provided. The minimum column and the maximum column include the shortest electronic auction time and the longest electronic time, respectively, for the commodity identified in the commodity name column. Similarly, the average column provides the average electronic auction time for that commodity name. Export button 1802 will export the data in the cycle time of request process by commodity Web page to a file compatible with a spreadsheet, such as Microsoft Excel. Back button 1804 returns the user to the summary report main menu of FIG. 14.

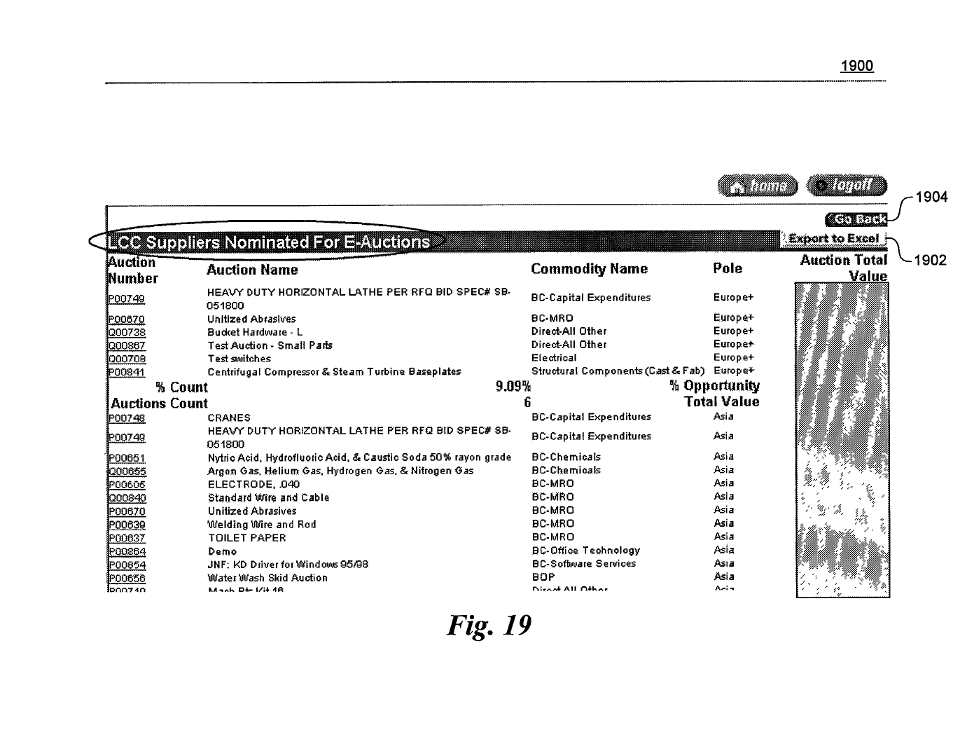

FIG. 19 illustrates a LCC nominated suppliers Web page 1900 of the electronic auction metrics system. The LCC nominated suppliers Web page is created when a user selects the LCC nominated suppliers link, as described in relation to FIG. 14, and indicates what LCC suppliers are in position to win bids. The LCC nominated suppliers Web page includes an auction number column, an auction name column, a commodity name column, a pole column, an auction total value column, and a group of metrics. The auction number column, the auction name column and the commodity name column help identify the auction and subject matter at issue. The pole column identifies the pole associated with the LCC supplier that was nominated, and the auction total value gives the potential value of the electronic auction. The metrics in the depicted embodiment include the number of auctions with nominated LCC suppliers and the percentage of these auction of the total number of auctions. Similarly, the metrics also include a combined value of the auctions with nominated LCC suppliers and a percentage reflecting the nominated LCC suppliers auctions compared to all auctions. Export button 1902 will export the data in the LCC nominated suppliers Web page to a file compatible with a spreadsheet, such as Microsoft Excel. Back button 1904 returns the user to the summary report main menu of FIG. 14.

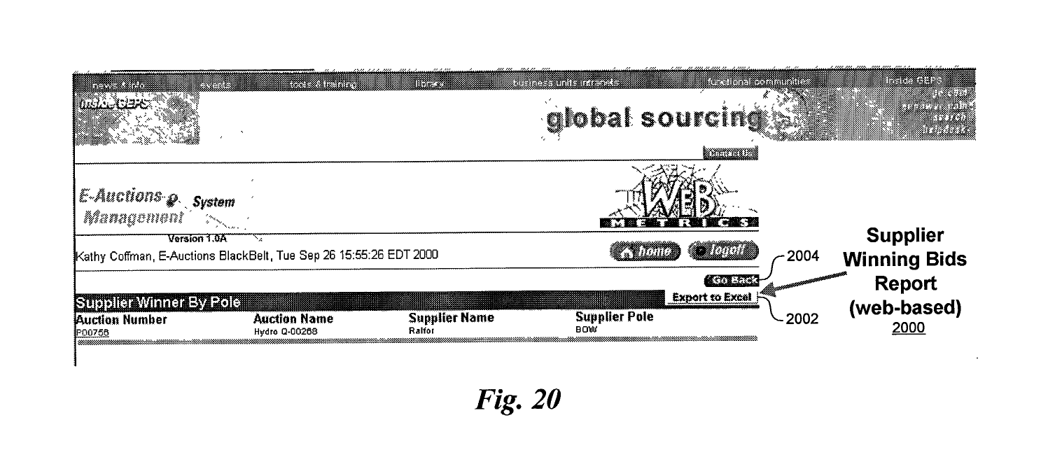

FIG. 20 illustrates a suppliers winner Web page 2000 of the electronic auction metrics system. The suppliers winner Web page is created when a user selects the suppliers winner link, as described in relation to FIG. 14, and lists all suppliers who have won a bid in an electronic auction. The suppliers winner Web page includes an auction number column, an auction name column, a supplier name column, and a supplier pole column. The auction number column and the auction name column help identify the auction at issue. The supplier name column provides the name of the supplier with the winning bid, and the supplier pole column identifies the pole associated with the supplier. Export button 2002 will export the data in the suppliers winner Web page to a file compatible with a spreadsheet, such as Microsoft Excel. Back button 2004 returns the user to the summary report main menu of FIG. 14.

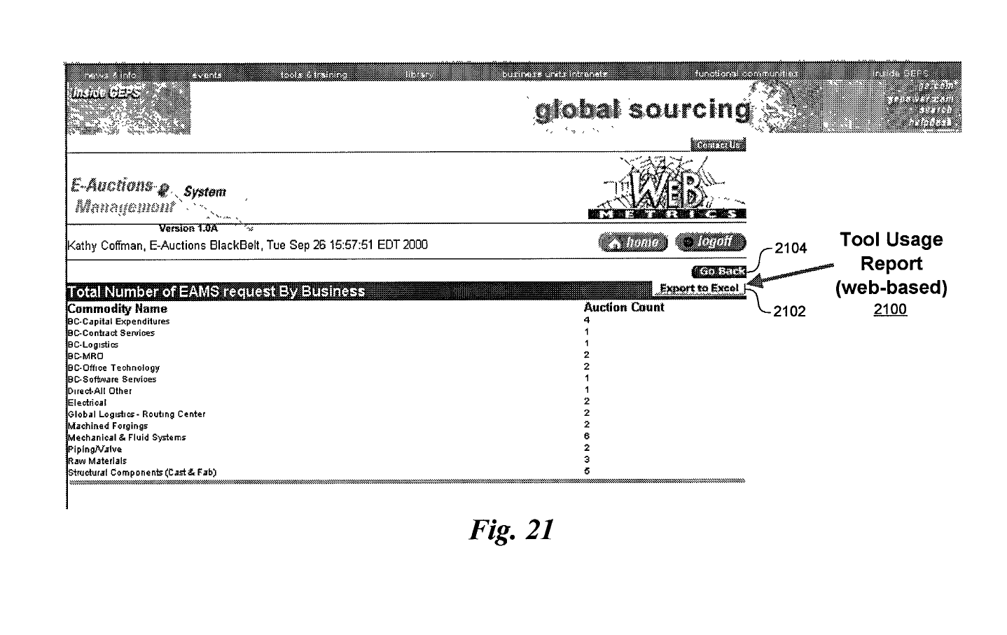

FIG. 21 illustrates a business total EAMS page 2100 of the electronic auction metrics system. The business total EAMS page is created when a user selects the business total EAMS link, as described in relation to FIG. 14, and lists the number of times that users from particular businesses have used the electronic auction metrics system. If the number is too low, it may indicate that a particular business is not taking full advantage of the electronic auction metrics system for a particular commodity. The business total EAMS page will therefore allow an administrator to determine which businesses are taking advantage of the electronic auction metrics system. The business total EAMS page includes a commodity name column and an auction count column, and may list all commodities associated with a particular business. The commodity name column simply lists the commodity and the auction count column provides the total number of uses of the electronic auction metrics system by members of selected business organization for each particular commodity. Export button 2102 will export the data in the business total EAMS page to a file compatible with a spreadsheet, such as Microsoft Excel. Back button 2104 returns the user to the summary report main menu of FIG. 14.

An alternative embodiment would include a web page that lists the number of times that users from particular businesses have used the electronic auction metrics system so that different businesses could be compared. If the number is too low, it may indicate that a particular business is not taking full advantage of the electronic auction metrics system. This embodiment would include a business name column and an auction count column. The business name column simply lists the business organization at issue and the auction count column provides the total number of uses of the electronic auction metrics system by members of that business organization.

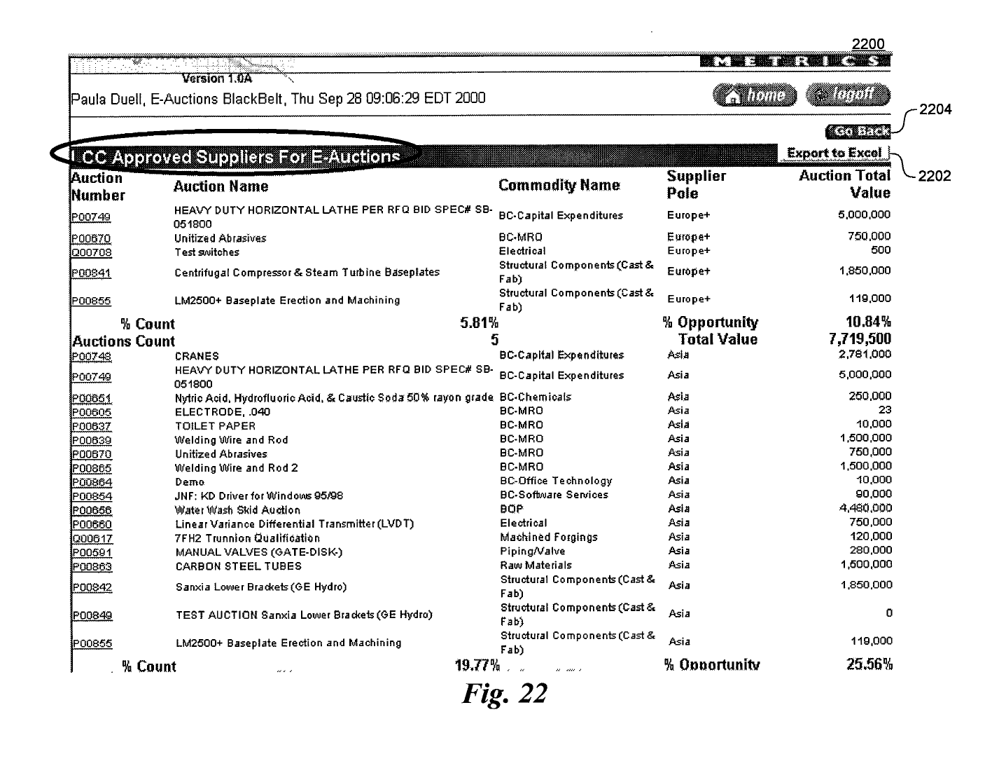

FIG. 22 illustrates a LCC approved suppliers web page 2200 of the electronic auction metrics system. The LCC approved suppliers web page is created when a user selects the LCC approved suppliers link, as described in relation to FIG. 14, and can indicate how effectively LCCs are being used. The LCC approved suppliers web page includes an auction number column, an auction name column, a commodity name column, a pole column, an auction total value column, and a group of metrics. The auction number column, the auction name column and the commodity name column help identify the auction and subject matter at issue. The pole column identifies the pole associated with the approved LCC supplier, and the auction total value gives the potential value of the electronic auction. The metrics in the depicted embodiment include the number of auctions with approved LCC suppliers and the percentage of these auction of the total number of auctions. Similarly, the metrics also include a combined value of the auctions with approved LCC suppliers and a percentage reflecting the nominated LCC suppliers auctions compared to all auctions. Export button 2202 will export the data in the LCC approved suppliers web page to a file compatible with a spreadsheet, such as Microsoft Excel. Back button 2204 returns the user to the summary report main menu of FIG. 14.

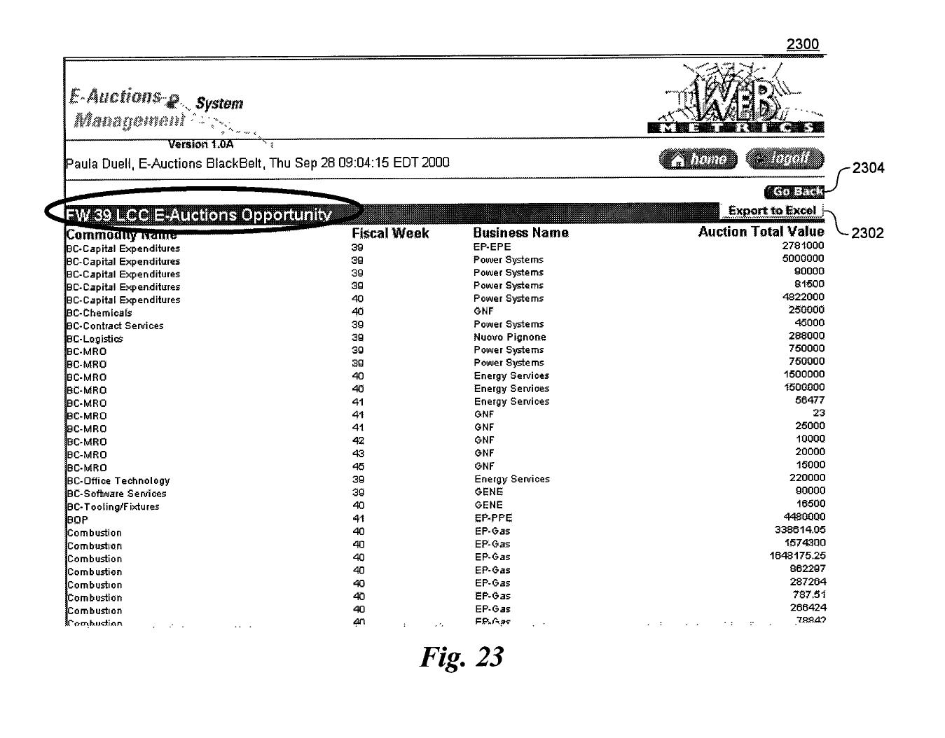

FIG. 23 illustrates a LCC opportunity web page 2300 of the electronic auction metrics system. The LCC opportunity web page is created when a user selects the LCC opportunity link, as described in relation to FIG. 14, and the LCC opportunity web page displays upcoming electronic auctions that provide an opportunity for LCC suppliers to win the bidding. The LCC opportunity web page includes a commodity name column, a fiscal week column, a business name column, and an auction total value column. The commodity name column and business name column help identify the auction and subject matter at issue. The fiscal week column provides the schedule time for the electronic auction, which can include more than one fiscal week (e.g., FW 39, FW 40, etc.). The auction total value column gives the potential value of the electronic auction. Export button 2302 will export the data in the LCC opportunity web page to a file compatible with a spreadsheet, such as Microsoft Excel. Back button 2304 returns the user to the summary report main menu of FIG. 14.

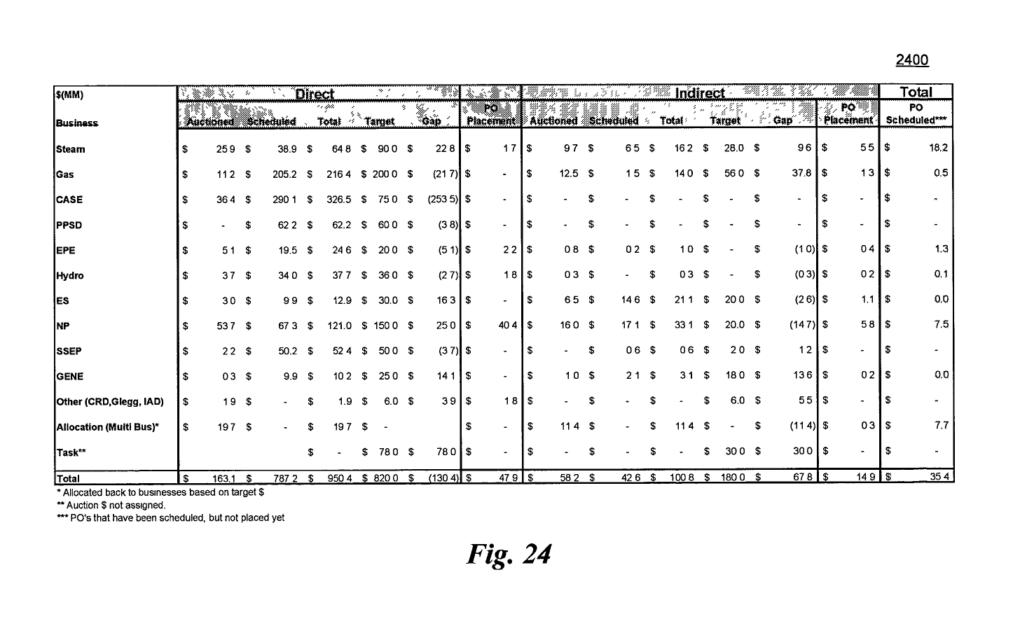

FIG. 24 illustrates a summary report Web page 2400 of the electronic auction metrics system. The summary report Web page is one alternative embodiment of the web page created when a user selects the summary button, as described in relation to FIG. 7. The summary report Web page is used to track electronic auctions and compare progress towards pre-defined goals and indicates areas for improvement. The summary report Web page includes an auctioned amount column, a scheduled auctioned amount column, a total auctioned amount column, a target column, a gap column, and a PO placement column, all for both direct and indirect electronic auctions, as well as a PO scheduled column. In the embodiment depicted in FIG. 24, the web page is configured as a report by business, but other alternatives are possible, such as a report by commodities and a report by businesses by commodities. The auctioned amount column includes the monetary value of completed auctions and the scheduled auction amount column includes the monetary value of scheduled auctions. The total auctioned amount is equal to the auctioned amount and the scheduled auction amount, and the target column includes a pre-defined goal. The gap column includes the difference between the target column and the total auction amount so that performance can be measured and compared. In addition, the PO placement column includes the total up to date PO placement amount, and the PO scheduled amount includes a pre-defined value. The summary report Web page also includes totals for each column, so that performance across the entire company can be tracked.

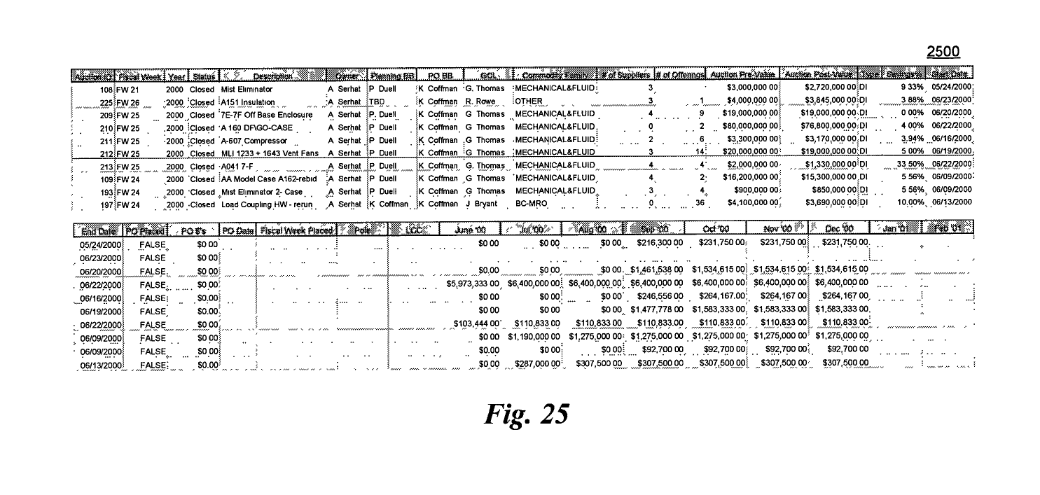

FIG. 25 illustrates a detail report Web page 2500 of the electronic auction metrics system. The detail report Web page is one alternative embodiment of the web page created when a user selects the detail reports button, as described in relation to FIG. 7. The detail report Web page is used to track individual electronic auctions and compare progress towards pre-defined goals. The detail report Web page includes a wide variety of columns, most of which are included in previously described web pages and are substantially similar in function. The detail report Web page also includes a planning BB column, a PO BB column, a GCL column, a number of suppliers column, a number of offerings column, a savings column, and a start date column. The planning BB column, the PO BB column, and the GCL column are used to identify the planning Blackbelt, the PO Blackbelt, and the GCL associated with the particular electronic auction, respectively. The number of suppliers column includes the number of suppliers who bid during the auction. The savings column includes the percentage savings achieved from the auction and is calculated based on the differences between the auction pre-value and the auction post-value. The start date column includes the date that the electronic auction first started. The detail report Web page also includes a chart of PO placements over time, such as the PO placements completed for each month.

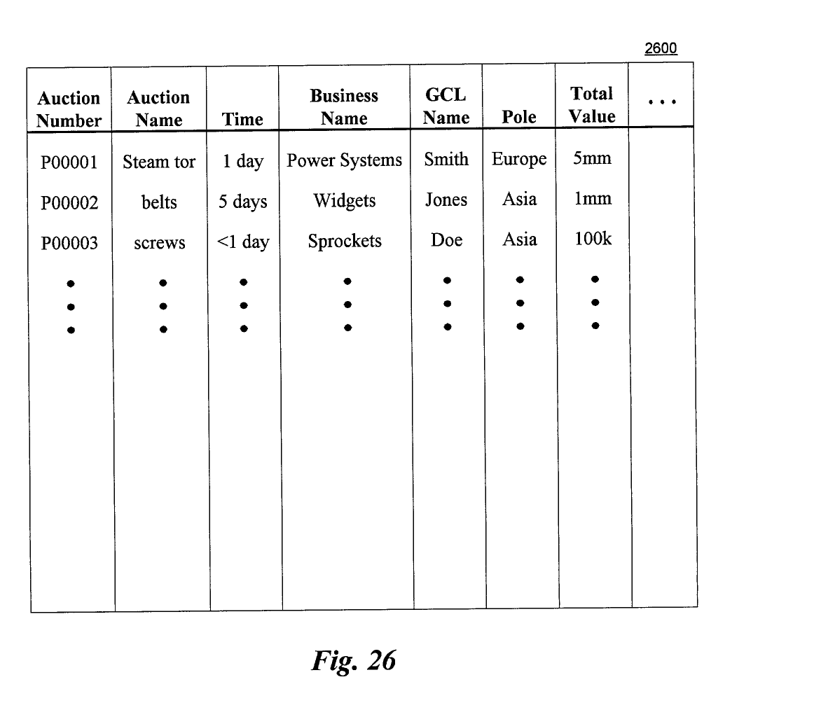

FIG. 26 is a block diagram illustrating data structures of a sample database table in one embodiment. This table represents a logical organization of the data. One skilled in the art would appreciate that varying physical organizations of the data may be used. Table 2600 includes an entry for each auction number, which is preferably a unique identifier. Associated with each auction number can be any number of additional details concerning that particular auction number, such as the auction name, the time the auction lasted, the business name, the commodity name, the GCL name, the pole of the winning supplier, the total value, etc. The ellipsis indicates that the table 2600 may contain additional information about each auction number. In one alternative embodiment, the information contained in table 2600 is spread over multiple databases (e.g., one database with auction number and auction name, another database with auction number and business name, etc.).

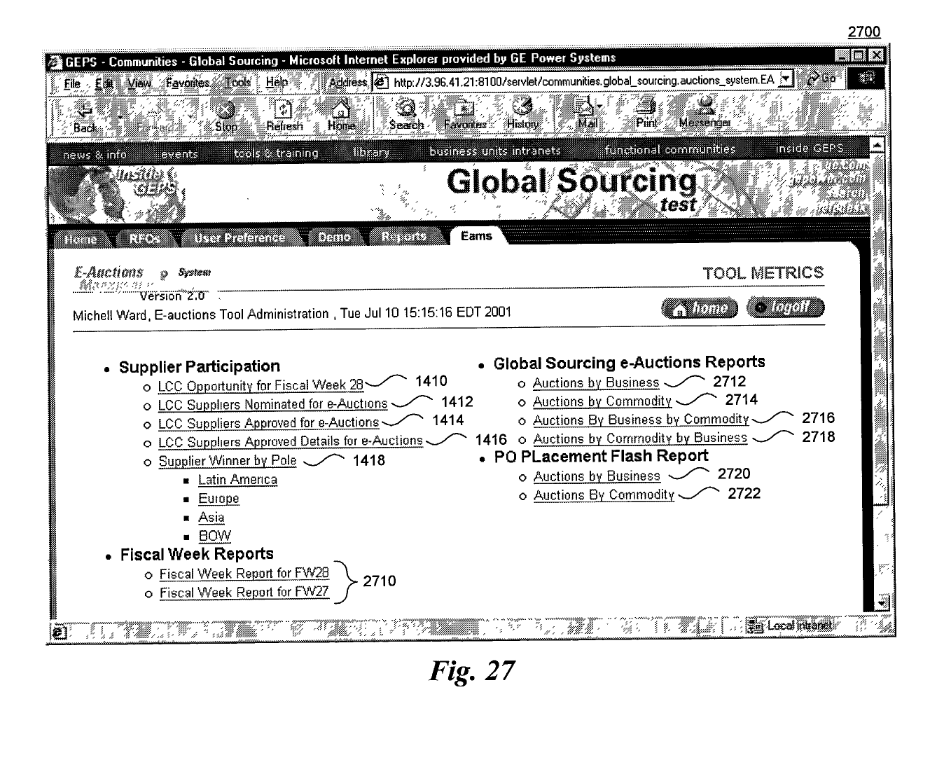

FIG. 27 illustrates one embodiment of a tool metrics main menu 2700 of the electronic auction metrics system. The tool metrics main menu includes, in the depicted embodiment, a variety of different links to allow a user to select a particular metrics report. The tool metrics main menu includes a list of supplier participation links, where each supplier participation link requests a metrics chart concerning suppliers who bid on electronic auctions or who won electronic auctions. The supplier participation links include an LCC opportunity link 1410, a LCC nominated suppliers link 1412, a LCC approved suppliers link 1414, a LCC approved suppliers details link 1416, and a supplier winner link 1418, all of which provide substantially similar functionality to the similarly numbered links described in relation to FIG. 14. The supplier winner link in this embodiment includes sub-links to allow a user to access summary reports of supplier winners for a particular pole (e.g., Latin America, Europe) directly from the tool metrics main menu.

The tool metrics main menu also includes, in the depicted embodiment, fiscal week report links 2710, global sourcing report links, and PO placement links. The fiscal week report links include one or more links to allows users to see a report summarizing electronic auction activity for a particular fiscal week (such as fiscal week 28 and fiscal week 27 in the depicted embodiment). The global sourcing report links include a global sourcing auctions by business link 2712, a global sourcing auctions by commodity link 2714, a global sourcing auctions by business by commodity link 2716, and a global sourcing auctions by commodity by business link 2718. The global sourcing auctions by business link allows users to request a summary report that lists relevant information, organized by business, concerning electronic auctions over a particular timeframe. The global sourcing auctions by commodity link allows users to request a summary report that lists relevant information, organized by commodity, concerning electronic auctions over a particular timeframe. The global sourcing auctions by business by commodity link allows users to request a summary report that lists relevant information concerning electronic auctions, where the information is organized by commodity and broken up by businesses within each commodity. The global sourcing auctions by commodity by business link allows users to request a summary report that lists relevant information concerning electronic auctions, where the information is organized by business and broken up by commodity within each business. The PO placement links include a PO placement by business link 2720 and a PO placement by commodity link 2722. The auctions by business link allows users to request a summary report, organized by business, of PO placement amounts scheduled and completed, as well as other PO information. The auctions by commodity link allows users to request a summary report, organized by commodity, of PO placement amounts scheduled and completed, as well as other PO information.

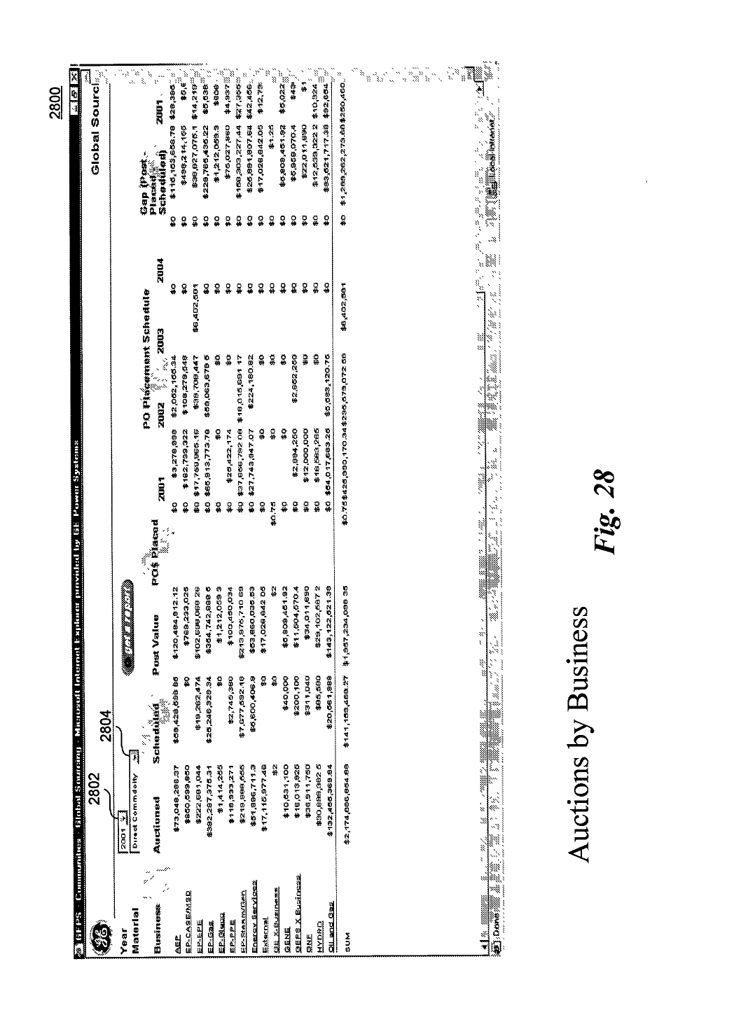

FIG. 28 illustrates a global sourcing auctions by business web page 2800 of the electronic auction metrics system. The global sourcing auctions by business web page is created when a user selects the global sourcing auctions by business link, as described in relation to FIG. 27, and can be used to provide summary information about auctions organized by the business associated with those auctions. The global sourcing auctions by business web page includes a year selector 2802 and a material selector 2804. The year selector may be used to select the timeframe for the summary data included in the report, and the material selector may be used to select they type of information included within the report. The global sourcing auctions by business web page includes a business column, an auctioned column, a scheduled column, a post valued column, a PO$ Placed column, PO placement schedule columns, and a gap column. The business column includes the name of the business for which summary information is provided. The auctioned column includes the monetary value of completed auctions for the specified business and the scheduled auction amount column includes the monetary value of scheduled auctions for the specified business. The post value column includes the monetary value of the actual amount of the winning bids for all of the electronic auctions for that business. The PO$ placed column indicates the total monetary value of all PO's placed for the specified business. The PO placement schedule columns indicate the projected PO placements for the specified business for each of the specified fiscal or calendar years. The gap column includes the total difference between the post value column and the PO placement schedule columns so that performance can be measured and compared.

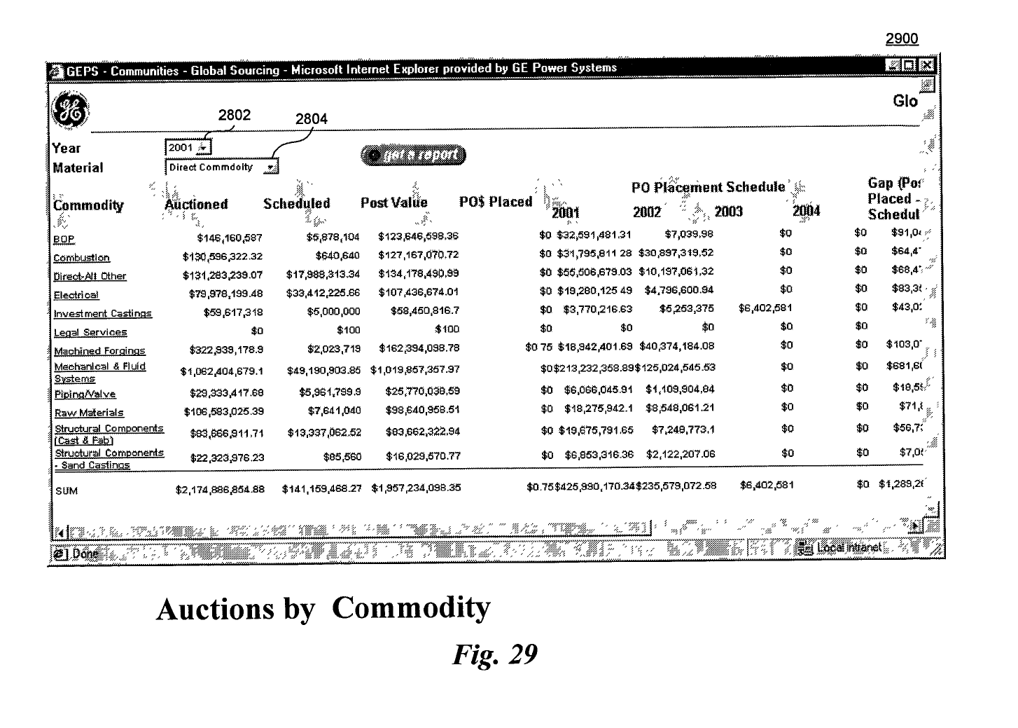

FIG. 29 illustrates a global sourcing auctions by commodity web page 2900 of the electronic auction metrics system. The global sourcing auctions by commodity web page is created when a user selects the global sourcing auctions by commodity link, as described in relation to FIG. 27, and can be used to provide summary information about auctions organized by the commodity associated with those auctions. The global sourcing auctions by commodity web page is similar in format to the global sourcing auctions by business web page except that it contains a commodity column instead of a business column. The commodity column includes the name of the commodity for which summary information is provided. The other columns and selectors provide substantially similar functions to those for the global sourcing auctions by business page, except that the totals are calculated and organized by commodity instead of by business.

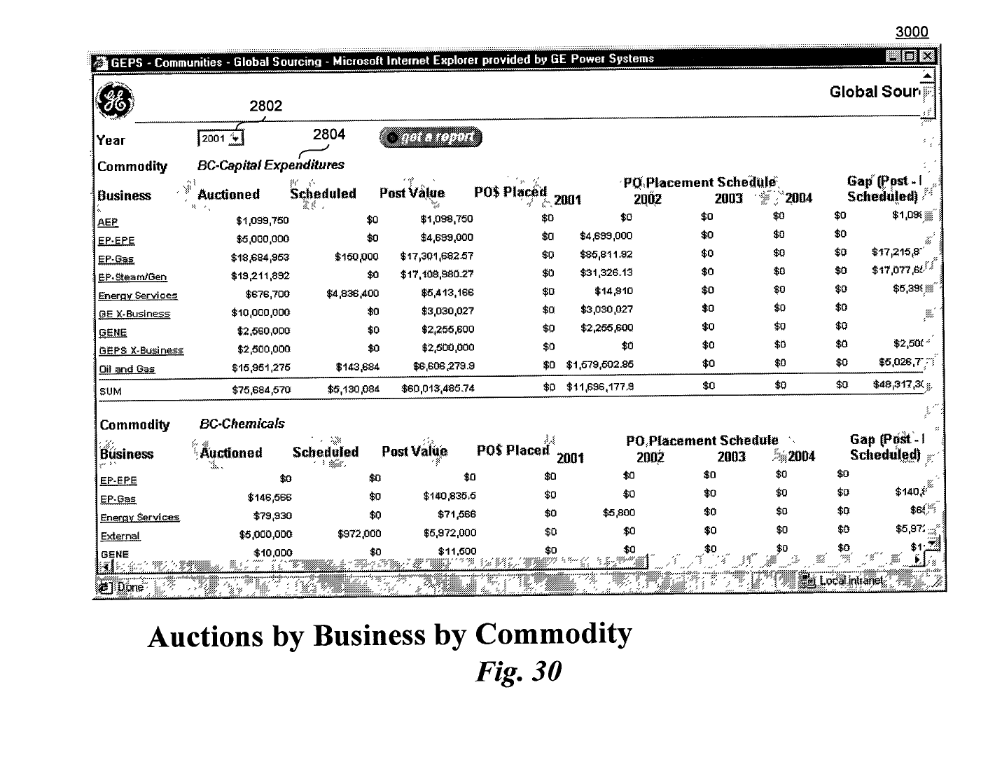

FIG. 30 illustrates a global sourcing auctions by business by commodity web page 3000 of the electronic auction metrics system. The global sourcing auctions by business by commodity web page is created when a user selects the global sourcing auctions by business by commodity link, as described in relation to FIG. 27, and can be used to provide summary information concerning electronic auctions where the information is organized by commodity and broken up by businesses within each commodity. The global sourcing auctions by business by commodity web page is similar in format to the global sourcing auctions by business web page except that the information is separated for each commodity, with lists of businesses for each commodity, instead of summarized in one amount for each business. The columns and selectors provide substantially similar functions to those for the global sourcing auctions by business page.

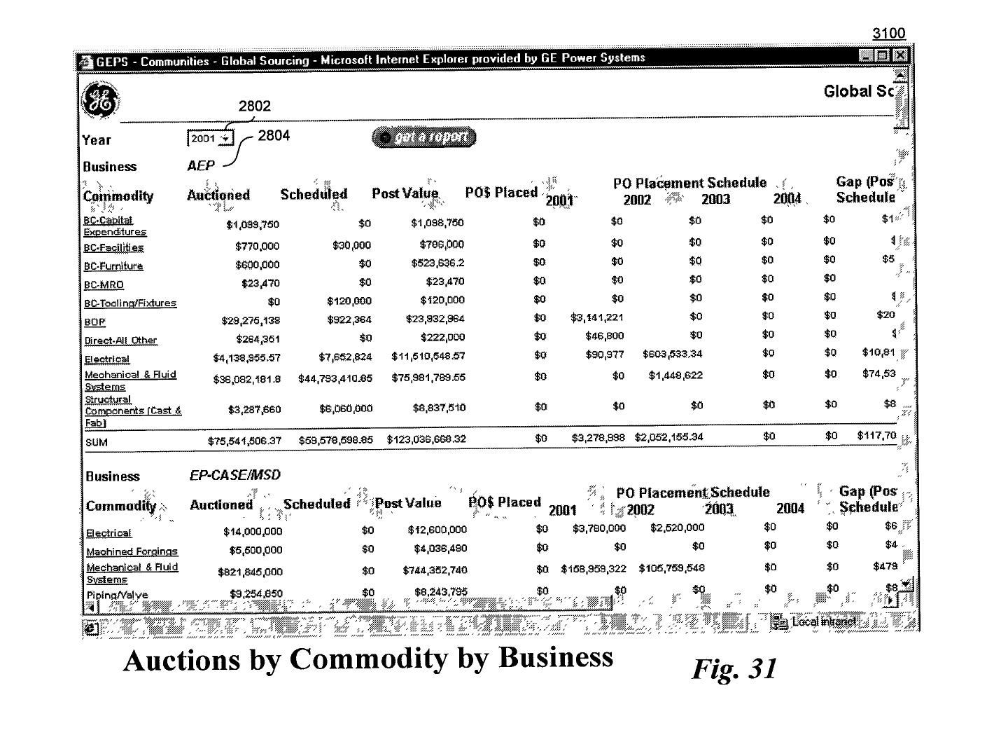

FIG. 31 illustrates a global sourcing auctions by commodity by business web page 3100 of the electronic auction metrics system. The global sourcing auctions by commodity by business web page is created when a user selects the global sourcing auctions by commodity by business link, as described in relation to FIG. 27, and can be used to provide summary information concerning electronic auctions where the information is organized by business and broken up by commodities within each business. The global sourcing auctions by commodity by business web page is similar in format to the global sourcing auctions by commodity web page except that the information is separated for each business, with lists of commodities for each business, instead of summarized in one amount for each commodity. The columns and selectors provide substantially similar functions to those for the global sourcing auctions by commodity page.

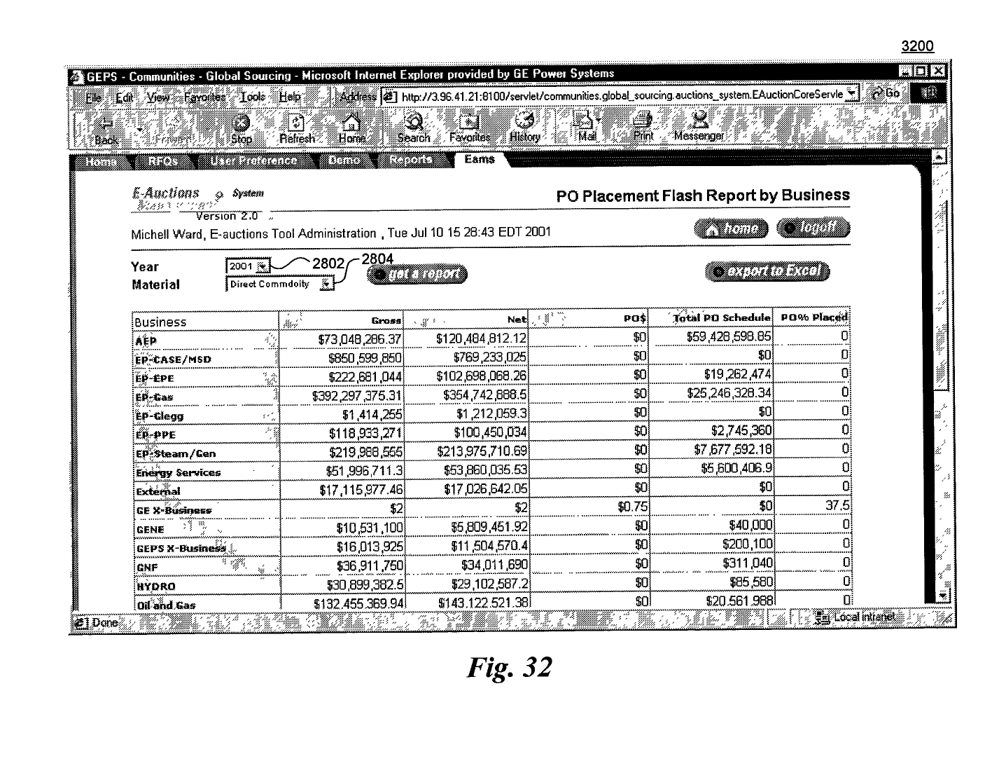

FIG. 32 illustrates the PO placement by business web page 3200 of the electronic auction metrics system. The PO placement by business web page is created when a user selects the PO placement by business link, as described in relation to FIG. 27, and provides information about PO placements for electronic auctions organized by business. The PO placement by business web page includes a year selector and a material selector, as described in relation to FIG. 28. The PO placement by business web page also includes a business column, a gross column, a net column, a PO$ column, a total PO scheduled column, and a PO % placed column. The business column includes the name of the business for which summary information is provided. The gross column includes a total monetary value of all electronic auctions conducted for the specified business, while the net column includes a total monetary value of the accepted bids for all electronic auctions conducted for the specified business. The PO$ column indicates the total monetary value of all PO's placed for the specified business. The total PO scheduled column indicates the projected PO placements for the specified business for the timeframe specified in the year selector. The PO % placed column indicates the percentage of the total PO's that have actually been placed.

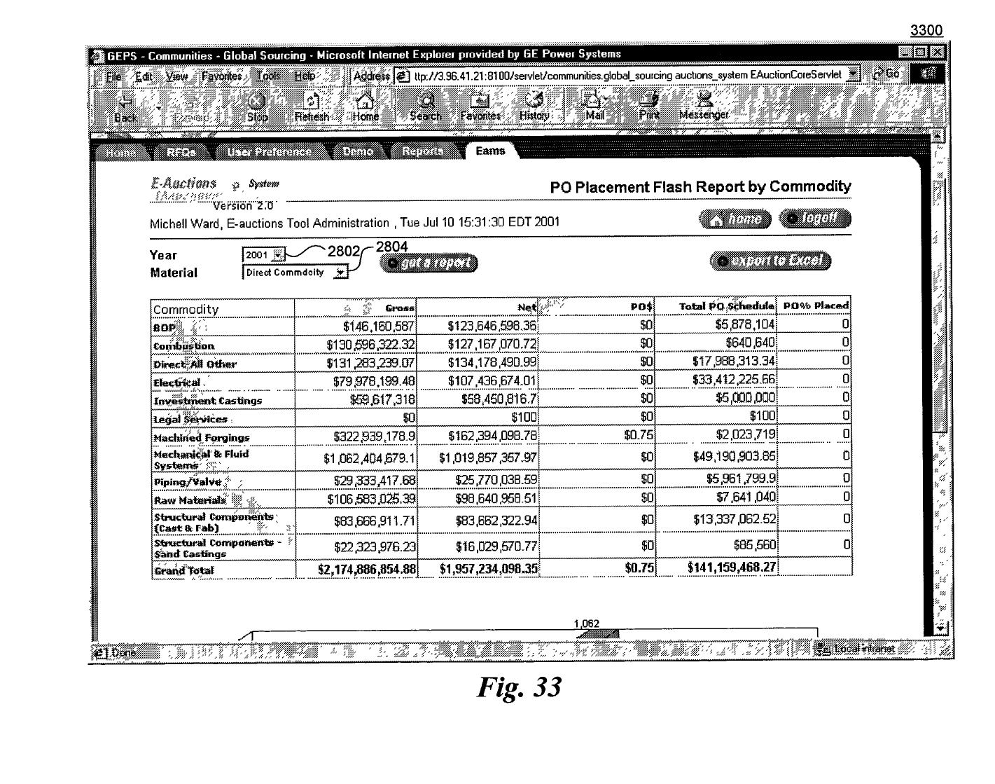

FIG. 33 illustrates the PO placement by commodity web page 3300 of the electronic auction metrics system. The PO placement by commodity web page is created when a user selects the PO placement by commodity link, as described in relation to FIG. 27, and provides information about PO placements for electronic auctions organized by commodity. The PO placement by commodity web page is similar in format to the PO placement by business web page except that it contains a commodity column instead of a business column. The commodity column includes the name of the commodity for which summary information is provided. The other columns and selectors provide substantially similar functions to those for the PO placement by business web page, except that the totals are calculated and organized by commodity instead of by business.

One skilled in the art will appreciate that the concepts of the above system can be used in various environments other than the Internet. For example, the concepts can also be used in an electronic mail environment in which electronic mail messages may be used to provide information on auctions and to place bids at the auctions. Additionally, various communication channels may be used instead of the Internet, such as a local area network, a wide area network, or a point-to-point dial-up connection. The server system may comprise any combination of hardware or software that can support these concepts. In particular, a Web server may actually include multiple computers. A client system may comprise any combination of hardware and software that interacts with the server system. The client systems may include television-based systems, Internet appliances and various other consumer products through which auctions may be conducted, such as wireless computers (palm-based, wearable, mobile phones, etc.) Moreover, the concepts of the present invention may be applied to auctions that are not supported by computer systems or that are only partially supported by computer systems.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” and words of similar import, when used in this application, shall refer to this application as a whole, and not to any particular portions of this application.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. The teachings of the invention provided herein can be applied to other electronic commerce systems, not only the reverse auction system described above.

The elements and steps of the various embodiments described above can be combined to provide further embodiments. All of the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, in the following claims, the terms used should not be construed to limit the invention to the specific embodiments disclosed in the specification and the claims, but should be construed to include all electronic commerce systems that operate under the claims to provide a method for procurement. Accordingly, the invention is not limited by the disclosure, but instead, the scope of the invention is to be determined entirely by the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

I (we) claim:

1. In a computer network connecting an electronic auction metrics computer and one or more electronic auction computers, wherein the electronic auction metrics computer is coupled to one or more user computers over a computer network, a method comprising:
receiving electronic auction information at the electronic auction metrics computer from one or more electronic auction computers, wherein the electronic auction information includes information about the results and performance of an electronic auction;
storing the electronic auction information in a metrics database, wherein the metrics database is coupled with the electronic auction metrics computer via a computer network;
receiving a request from a user computer for a specified metrics report, wherein the user specifies details about the report including subject matter of the report, timeframe for the report, and report delivery method;
transmitting a request to the metrics database for metrics data, wherein the metrics data that is requested is based on the report request from the user;
receiving the metrics data from the metrics database;
creating a metrics report based on the request from the user computer, wherein the data used to create the metrics report is the metrics data received from the metrics database; and
providing the metrics report to the user via a delivery method specified by the user in the report request.

2. The method of claim 1 wherein the computer network is the World Wide Web, and
wherein receiving electronic auction information occurs automatically at pre-determined intervals;
wherein the electronic auction information includes a business, a commodity, an auction value, and a date of completion; and
further comprising processing the electronic auction information before the electronic auction information is stored in the metrics database.

3. In a computer network connecting an electronic auction metrics computer and one or more electronic auction computers, wherein the electronic auction metrics computer is coupled to one or more user computers over a computer network, a method comprising:
receiving electronic auction information at the electronic auction metrics computer from one or more electronic auction computers;
storing the electronic auction information in a metrics database;
receiving a request from a user computer for a specified metrics report;
searching the metrics database for metrics data, wherein the metrics data is based on the electronic auction information;
creating a metrics report based on the request from the user; and
providing the metrics report to the user computer.

4. The method of claim 3 further comprising requesting electronic auction information from one or more electronic auction computers.

5. The method of claim 3 further comprising transmitting electronic auction information to the electronic auction metrics computer automatically at predetermined intervals from one or more electronic auction computers.

6. The method of claim 3 wherein the user request includes details about the requested report including subject matter of the report, timeframe of the report, and a report delivery method.

7. The method of claim 3 wherein the electronic auction metrics computer is the same as the one or more electronic auction computers.

8. A system to assist in generating metrics reports based on reverse electronic auctions performed by one or more electronic auction computers, comprising:
means for receiving electronic auction information from one or more electronic auction computers;
means for storing the electronic auction information;
means for receiving a request for a metrics report;
means for searching the metrics database for metrics data;
means for creating a metrics report; and
means for providing the metrics report to the user.

9. In a computer network connecting an electronic auction metrics computer and one or more electronic auction computers, wherein the electronic auction metrics computer is coupled to one or more user computers over a computer network, an electronic auction metrics system comprising:
a gather component for receiving electronic auction information at the electronic auction metrics computer from one or more electronic auction computers;
a database for storing the electronic auction information;
a submission component for receiving requests for metrics reports from users on user computers, wherein the user request includes parameters of the desired report,
a metrics report component for creating a metrics report, wherein the metrics report is based on parameters specified by the user and the electronic auction information stored in the database; and
a display component for displaying the metrics report to the user.

10. The system of claim 9 wherein the electronic auction metrics computer and at least one electronic auction computer are the same computer.

11. In a computer network connecting an electronic auction metrics computer and one or more electronic auction computers, wherein the electronic auction metrics computer is coupled to one or more user computers over a computer network, a method comprising:
receiving electronic auction information from one or more electronic auction computers;
storing the electronic auction information in a metrics database;
receiving a request from a user computer for a specified metrics report;
searching the metrics database for metrics data, wherein the metrics data is based on the electronic auction information;
creating a metrics report based on the request from the user; and
transmitting the created metrics report to the user computer.

12. The method of claim 11 further comprising requesting electronic auction information from one or more electronic auction computers.

13. The method of claim 11 wherein electronic auction information is received automatically at predetermined intervals from one or more electronic auction computers.

14. The method of claim 11 wherein the user request includes the desired subject matter of the report.

15. The method of claim 11 wherein the user request includes a delivery method for the report.

16. The method of claim 11 wherein the user request includes a start time and an end time for the metrics data used to create the metrics report.

17. The method of claim 11 wherein the metrics report includes electronic auctions performed only for a certain business.

18. The method of claim 11 wherein the metrics report includes electronic auctions performed to acquire a particular commodity.

19. The method of claim 11 further comprising calculating the savings achieved through use of electronic auctions, wherein the savings is based on a pre-auction value and a post-auction value, and wherein further the created metrics report includes the savings achieved for each electronic auction.

20. In a computer network connecting an electronic auction metrics computer and one or more electronic auction computers, wherein the electronic auction metrics computer is coupled to one or more user computers over a computer network, the electronic auction metrics computer comprising:
means for receiving electronic auction information;
means for processing the electronic auction information;
means for storing the electronic auction information;
means for receiving a request for a specified metrics report;
means for creating a metrics report based on the electronic auction information; and
means for transmitting the created metrics report.

21. A computer-readable medium whose contents cause a computer to generate an electronic auction metrics report by a method comprising:
receiving electronic auction information from one or more electronic auction computers;
receiving a request from a user computer for a specified metrics report;
creating a metrics report based on the request from the user and the electronic auction information received; and
transmitting the created metrics report to the user computer.

22. The computer-readable medium of claim 21 further comprising storing the electronic auction information in a database.

23. The computer-readable medium of claim 21 further comprising requesting electronic auction information from one or more electronic auction computers.

24. The computer-readable medium of claim 21 wherein electronic auction information is received automatically at pre-determined intervals from one or more electronic auction computers.

25. The computer-readable medium of claim 21 further comprising calculating the savings achieved through use of electronic auctions, wherein the savings is based on a pre-auction value and a post-auction value, and wherein further the created metrics report includes the savings achieved for each electronic auction.

26. In a computer network connecting an electronic auction metrics computer and one or more electronic auction computers, wherein the electronic auction metrics computer is coupled to one or more user computers over a computer network, a method comprising:
at a user computer, receiving from a user a request for a metrics report based on electronic auction information;
at a user computer, sending to an electronic auction metrics computer a request for a metrics report, wherein the request includes information identifying the type of metrics report desired;
at a user computer, receiving from the electronic auction metrics computer an indication of the metrics report; and
at a user computer, displaying to the user the metrics report.

27. The method of claim 26 wherein the user request includes a delivery method for the report.

28. The method of claim 26 wherein the electronic auction metrics computer, upon receiving the request that the user desires a metrics report, searches a metrics database and creates a metrics report based on the electronic auction information.

29. The method of claim 26 wherein the user request includes a start time and an end time for the metrics data used to create the metrics report.

30. The method of claim 26 wherein the user request includes a business.

31. The method of claim 26 wherein the user request includes a commodity.

32. The method of claim 26 wherein the type of metrics report specified by the user is a standard metrics report.

33. The method of claim 26 wherein the type of metrics report specified by the user is a non-standard metrics report.

34. A computer-readable medium containing a data structure for use by an electronic auction metrics system, the data structure comprising:
metrics auction information, wherein the metrics auction information includes
an auction number,
a commodity,
a business,
an auction value,
a date,
a description of the product procured, and
an identification of a person responsible for the electronic auction.

35. The computer-readable medium of claim 34 wherein the computer-readable medium is a logical node in a computer network receiving the contents.

36. The computer-readable medium of claim 34 wherein the computer-readable medium is a computer-readable disk.

37. The computer-readable medium of claim 34 wherein the computer-readable medium is a data transmission medium transmitting a generated data signal containing the contents.

38. The computer-readable medium of claim 34 wherein the computer-readable medium is a memory of a computer system.
